(19) United States
(12) Patent Application Publication
(10) Pub. No.: US 2008/0293609 A1
(43) Pub. Date: Nov. 27, 2008

(54) ABSORPTIVE PARTICLES

(76) Inventors: Rene-Andres Artiga Gonzalez, Dusseldorf (DE); Andreas Bauer, Kaarst (DE); Stefan Hammelstein, Dusseldorf (DE); Jurgen Hilsmann, Dusseldorf (DE); Wolfgang Lahn, Willich (DE); Mario Sturm, Leverkusen (DE); Hubert Harth, Hilden (DE); Ingrid Kraus, Dusseldorf (DE)

Correspondence Address: PAUL & PAUL, 2000 MARKET STREET, Suite 2900, PHILADELPHIA, PA, 19103-3229, US

(21) Appl. No.: 11/735,668

(22) Filed: Apr. 16, 2007

(30) Foreign Application Priority Data
Oct. 15, 2004 (DE) 10 2004 050 562.4
Sep. 8, 2005 (EP) PCT/EP05/09650

(51) Int. Cl. C11D 3/02

(52) U.S. Cl. 510/302

(57) ABSTRACT

A method to obtain particles which can absorb large quantities of perfume. The resulting particles are mechanically stable, flow freely, and have no tendency to stick together even when being charged with a great quantity of perfume. The perfume can be stabilized in the particles in such a way that the contained fragrances essentially do not decompose. Also disclosed are the aftertreatment of such particles as well as a detergent composition containing the inventive particles.

### CROSS-REFERENCE TO RELATED APPLICATIONS

This application is a continuation under 35 U.S.C. § 365(c) and 35 U.S.C. § 120 of International Application No. PCT/EP2005/009560, filed Sep. 8, 2005, which is incorporated herein by reference in its entirety. This Application also claims priority under 35 U.S.C. § 119 of German Application No. DE 10 2004 050 562.4, filed, Oct. 15, 2004, which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention relates to a method for manufacturing particles by drying, in particular, by spray drying or fluidized bed methods, carbon dioxide being generated during the drying process in the material to be dried. It further relates to particles which can be manufactured according to such a method and are post-treated. It further relates to a detergent composition that contains such particles and additionally surfactants and, if applicable, further constituents, as well as a method for textile laundering using the detergent composition.

Odorants, essences, and aromas, which are grouped—in particular when they are pleasant-smelling to human beings—under the term “fragrances,” have been part of human culture from time immemorial, and are generally used to produce pleasant smells or to conceal unpleasant ones. They are utilized nowadays in many everyday products.

The aromas and essences, for example, have considerable significance in the field of foodstuffs and comestibles. These are, in general, concentrated preparations of odorants or flavors, which are provided in order to impart a better or more intensive odor or taste to foodstuffs. The acceptance of foodstuffs and luxury consumables by the consumer can therefore be further increased by the addition of aromas and essences.

Fragrances are also often added to washing and cleaning agents and the like; these fragrances themselves generally have no (or comparatively few) cleaning properties, but once again enhance product acceptance among users, since the scenting of the product itself, the concealment of obtrusive secondary odors from the washing bath, and textile scenting by way of the product, are all desirable. For example, when fragrances are transferred from the washing agent onto the textile during textile laundering, the consumer usually perceives this very positively, and associates the pleasant smell of the laundry with its cleanliness, e.g., by noting that a shirt smells “freshly washed.”

It is therefore very common today, in textile laundering, treatment, and post-treatment, to mix into the washing agents and post-treatment agents specific quantities of perfume which serve to impart a pleasant scent to the washing or rinsing bath itself but also to the textile material treated with the washing or rinsing bath. The scenting of washing and cleaning agents, as well as post-treatment agents, is an important aspect of the aesthetic product impression alongside color and appearance, and thus a significant factor in the consumer's decision for or against a certain product. For scenting, the perfume either can be incorporated directly into the agents or delivered to the washing or rinsing bath in an additional step. The first approach defines a specific product characteristic; with the second approach, the consumer can decide individually, by way of different scent variants that are offered, as to “his” or “her” scent, comparably to the selection of an eau de toilette or aftershave.

(2) Description of Related Art, Including Information Disclosed Under 37 C.F.R. §§ 1.97 and 1.98.

Shaped fragrance elements and methods for scenting washing and rinsing baths are accordingly described extensively in the existing art. DE 41 33 862 (Henkel), for example, discloses tablets that contain carrier materials, fragrances, and if applicable further ingredients usual in washing and cleaning agents, sorbitol, and additionally 20 to 70 wt % of a bubbling system made up of carbonate and acid, are used as a carrier material. These tablets, which can, for example, be added to the rinsing and conditioning cycle during textile laundering in a household washing machine, contain approximately 3 to 15, by preference 5 to 10 wt % fragrance. Because of the high bursting-agent content of the tablets, they are sensitive to atmospheric moisture and must be correspondingly protected during storage.

DE 39 11 363 (Baron Freytag von Loringhoven) discloses a method for producing a washing or rinsing bath enriched with fragrance, and a fragrance-addition agent serving that purpose. The addition agents, which are present in the form of capsules or tablets, contain the fragrance together with an emulsifier in liquid form (capsules) or bound to filler and carrier substances (tablets), sodium aluminum silicates or cyclodextrins being recited as carrier substances. The fragrance content of the capsules or tablets is at least 1 g, the volume of the agents being greater than 1 cm³. Tablets or capsules having more than 2.5 g fragrance and a volume of at least 5 cm³ are preferred. In storage, tablets or capsules of this kind must be equipped with a gas- and water-tight encasing layer in order to protect the ingredients. Further details regarding the production and physical properties of suitable tablets are not contained in this document.

International Application WO 94/25563 (Henkel-Ecolab) describes a method for manufacturing shaped elements having washing and cleaning activity using microwave technology, which method works without high-pressure compaction. The shaped elements manufactured in this fashion are notable for an extremely high dissolution or disintegration rate simultaneously with fracture resistance, with no need for a bursting agent. At the same time, they are stable in storage and can be stored without additional precautions. It is also possible in this fashion to manufacture shaped elements that have a perfume-oil content, usual for washing and cleaning agents, of between 1 and 3 wt %. Perfume oils are usually volatile and can therefore be volatilized simply by the action of microwave radiation. When higher proportions of volatile liquid substances are to be used, a two-component system made up of one component manufactured using microwave technology and one component containing the sensitive liquid substances is therefore described.

Particulate additives for scenting washing baths and for use in washing and cleaning agents, as well as methods for their manufacture, are described in international Patent Applications WO 97/29176 and WO 97/29177 (Procter & Gamble). According to the teaching of these documents, porous carrier materials (e.g. sucrose mixed with zeolite X) have perfume added to them, and lastly are coated with a coating material (carbohydrates) and are adjusted to the desired particle size distribution.

German Patent Application DE 197 35 783 A1 (Henkel) describes high-concentration shaped fragrance elements that contain carrier material(s), 20 to 50 wt % fragrance(s), and if applicable further active substances and adjuvants that are usual in washing and cleaning agents, at least 50 wt % of the weight of the shaped elements, after subtraction of the fragrance quantity, being made up of fatty acids and fatty-acid salts. These shaped fragrance elements are suitable both for scenting washing and cleaning agents and for scenting textiles in a washing machine.

A method for applying fragrances onto textile material in a washing machine is described in DE 195 30 999 (Henkel). In this method, a fragrance-containing shaped element that is manufactured by irradiation with microwaves is used in the rinse cycle of a washing machine. Manufacture of the preferably spherical shaped elements, having diameters above 3 mm and bulk weights of up to 1,100 g/l, is achieved, according to the teaching of this document, by the fact that a mixture of predominantly water-soluble carrier materials, hydrated substances, optionally surfactants, and perfume is introduced into suitable molds and sintered with the aid of microwave radiation. The fragrance contents of the shaped elements are between 8 and 40 wt %; starches, silicic acids, silicates and disilicates, phosphates, zeolites, alkali salts of polycarboxylic acids, oxidation products of polyglucosans, and polyaspartic acids are used as carrier materials. A prerequisite, described as essential, of the shaped element manufacturing method described in this method is that bound water be present at least in part in the mixture that is sintered with the aid of microwave radiation to produce shaped elements, i.e. that some of the starting materials be present in hydrated form.

The proposed solutions recited in the existing art either require additional barrier layers or encasing layers in order to immobilize the perfume on the carrier, or are not equally suitable for scenting washing and cleaning agents and for direct use as a sole scenting agent, for example, for the rinse cycle in a washing machine.

### BRIEF SUMMARY OF THE INVENTION

Against this background, the object of the present invention was to make possible the provision of particles that can absorb larger quantities of fragrance and can be incorporated, without a gas-tight encasing layer, into other agents such as, for example, washing and cleaning agents.

This object is achieved by a method for particle manufacture in which a paste is subjected to drying, wherein carbon dioxide is generated during the drying process in the material to be dried.

### BRIEF DESCRIPTION OF THE SEVERAL VIEWS OF THE DRAWING(S)

Not Applicable

### DETAILED DESCRIPTION OF THE INVENTION

“Pastes” preferably means, for purposes of this invention dispersions of solids in liquids having a very liquid to very doughy, i.e., viscous, consistency. A preferred paste for purposes of this invention is a slurry, i.e., a preferably aqueous suspension of solids having a very liquid to very pulpy or pasty consistency.

“Drying” means, in the broadest sense, any industrial drying capability with which water and/or other solvents can be removed from the pastes so thoroughly that particles, e.g., particulate solid materials, at the completion of drying, occur. Solid materials are substances having a solid external form. These particles, of course, need not be entirely solvent-free and/or anhydrous—for example, they can still contain considerable quantities of solvent and/or water—but they have water concentrations by preference below 30 wt %, advantageously below 25 wt %, in particular below 20 wt %, based in each case on the solid material occurring at the completion of drying. The water content can be even lower if desired, for example below 15 wt % or below 10 wt % or below 5 wt %, based in each case on the solid material occurring at the completion of drying.

For drying, heat is advantageously delivered to the products to be dried. Drying can preferably be accomplished in parallel flow, counterflow, or cross-flow. Depending on the type of heat delivery, a distinction is made among contact driers, convection driers, and radiative driers. Depending on the pressure present in the drier, a division is made into overpressure, standard-pressure, and vacuum driers. In convection drying, heat is transferred to the material to be dried predominantly by hot gases (air or inert gas), which is preferred. Channel, chamber, belt, shaft, fluidized bed, and atomization drivers are used for this, which is preferred. In contact drying, which is likewise preferred, heat transfer is accomplished via heat exchanger surfaces. Contact driers include the roller, tube, and cabinet driers. Shelf, plate, drum, and paddle driers operate according to both heat-delivery principles.

A drying method that is very preferred according to the present invention is spray drying. Fluidized bed methods are likewise preferred for drying.

According to a preferred embodiment of the invention, the paste to be processed according to the present invention contains (a) substance(s) that release carbon dioxide at elevated temperatures, selected by preference from hydrogencarbonate compounds, citric acid, and/or aconitic acid. Among the hydrogencarbonate compounds, sodium hydrogencarbonate is preferred.

According to a further preferred embodiment of the invention, the paste to be processed according to the present invention contains 0 to 40 wt %, by preference, 0.1 to 4 wt %, in particular, 1 to 3 wt % citric acid, or 0 to 50 wt %, by preference, 0.1 to 5 wt %, in particular, 1 to 4 wt % hydrogencarbonate compound, or 0 to 40 wt %, by preference, 0.1 to 10 wt %, in particular, 1 to 5 wt % aconitic acid.

It can also be advantageous to use mixtures of hydrogencarbonate compounds, citric acid, and/or aconitic acid, in which context the total quantity of such a mixture should not exceed 50 wt %, by preference 40 wt %, advantageously 20 wt %, but in particular 10 wt %, and a minimum total quantity should not be less than 0.1 wt %, by preference 1 wt %, based in each case on the entire paste.

The (spray) drying of aqueous preparations of useful materials that are suitable, for example, for use in washing and cleaning agents, and the drying of aqueous preparations of agents such as, for example, washing and cleaning agents as such for the manufacture of corresponding agents in a pourable bulk powder form, is a well known technical field. From the extensive technical literature, reference will be made here, merely by way of example, to K. Masters, “Spray Drying Handbook,” Longman Scientific & Technical 1991, ISBN 0-582-06266-7. Fluidized bed drying, which can be performed for purposes of the invention in conventional systems, is also a well known technical field and therefore need not be further explained here.

For implementation of the spray-drying method it is once again possible to use conventional systems such as those already utilized, for example, for the manufacture of conventional sprayed washing-agent components or washing agents. Such systems are usually made up of towers that are round in cross section and are equipped in the upper part with annularly arranged spray nozzles. They furthermore possess delivery apparatuses for the drying gases, and dust-removal systems for the exhaust air. The drying gas can be used for counterflow drying or parallel-flow drying. In so-called counterflow drying, the drying gas is introduced into the lower part of the tower and guided in the opposite direction from the product stream, whereas in parallel-flow drying, delivery of the drying gases is performed at the top of the drying tower. The spray-drying system is operated with hot air or hot combustion gases that by preference are introduced tangentially into the tower, thereby creating a certain swirl effect.

The first step of a spray-drying method ordinarily consists in the production of an aqueous suspension (paste, in particular slurry) of more or less thermally stable ingredients that, as a rule, for the most part neither volatilize nor decompose under the conditions of spray drying. This paste is then usually conveyed via pumps into the spray tower and there, in the top thereof, is as a rule sprayed through nozzles, or possibly a rapidly rotating atomizer disk, to yield a fine mist.

This spray mist is dried with a gaseous drying medium such as, by preference, hot air or an inert gas in counterflow or parallel flow. If the paste contains very temperature-sensitive constituents, delivery of the drying gas is then as a rule performed in parallel flow from above. For example, the hot air at approximately 250° C. to 350° C. evaporates the adhering water or solvent so that at the tower outlet (temperatures by preference 80-120° C.) the other paste constituents are obtained as a powder. The powder that has been spray-dried in this fashion can now be used directly, it can be post-treated, and it can be mixed with other components, including in particular with temperature-labile constituents such as, for example, fragrances in the case of washing agents.

The heat of the drying gas, whose temperature is by preference >100° C., advantageously >150° C., with further advantage >180° C., even more advantageously >200° C., in which context an upper limit of 400° C., by preference 350° C., advantageously 300° C., in particular 250° C. should not be exceeded, not only causes the adhering water or solvent to be evaporated, but also causes, by preference, carbon dioxide to be generated during drying in the material to be dried. The carbon dioxide is released by substances contained in the paste. Substances that have the potential to release carbon dioxide under such conditions are by preference selected from hydrogencarbonate compounds, citric acid, and/or aconitic acid.

Surprisingly, it has been possible to establish that in cases in which carbon dioxide is released during drying, the particles that result are notable for a distinctly elevated absorption capability for fragrances. For purposes of this invention, the term “fragrances” encompasses the totality of the odorants, aromas, essences, perfume oils, and perfumes, these terms, in particular the terms “fragrances” and “perfumes,” also being used synonymously hereinafter. “Perfumes” are generally understood as alcohol solutions of suitable odorants.

The direct product of drying, in particular, the direct product of spray drying, is capable of absorbing larger quantities than usual of fragrances in a subsequent treatment step. It has been established, surprisingly, that the pouring properties of particles scented in this fashion are very good. The pouring properties, in fact, remain very good even with a very high perfume loading. The same is true for mechanical stability. It is surprising that these scented particles also have a longer-lasting fragrance effect, i.e. the particles also provide fragrance, with at least the same fragrance intensity, longer than conventional products of (spray) drying that are otherwise scented analogously.

A further advantage of the invention is the fact that the fragrance note or perfume note of the particle according to the present invention that has been loaded with fragrances does not change disadvantageously even upon extended storage. It is often the case that perfume that is incorporated into a carrier material decomposes at least in part, more or less slowly, in the carrier material. This decomposition is, however, at least delayed in a particle according to the present invention. A perfume-stabilizing effect is thus achieved by the invention. This is also the case, in particular, when the particle is incorporated into an object, for example, into a detergent formulation, which because of its object properties (e.g., its alkalinity) is fairly detrimental to the stability of perfume. Here the result of the perfume-stabilizing effect is particularly favorable.

Further advantages are also provided by the subject matter of the invention. It has been found that the particles according to the present invention, once they have been loaded with perfume, result in a more intensive fragrance experience for the consumer, as compared with conventional particles in which no carbon dioxide is formed during the drying process, for the same perfume loading, for example, when washing laundry with a detergent formulation that contains the particles according to the present invention. It has been found, surprisingly, that the consumer perceives a more intensive fragrance in the washed laundry as compared with laundry that was washed with a conventionally perfumed detergent formulation, even when the absolute quantity of perfume contained was the same. The invention thus makes possible a fragrance-intensifying effect that relates directly to the particles and to objects into which said particles are incorporated, for example, detergent formulations, as well as items (such as, for example, textiles) that are treated with the objects (in this case, a detergent formulation).

It has furthermore been established, surprisingly, that the fragrance impression resulting from the particles according to the present invention that have been loaded with perfume lasts longer, both directly and indirectly. “Directly” means, in this connection, that the particle according to the present invention is fragrant over a longer period of time than an otherwise comparable particle in which, however, no CO₂ was released during drying. “Indirectly” means in this connection that objects (e.g., a detergent formulation) that contain the particle according to the present invention are fragrant longer, and that, in fact, when these objects (e.g., a detergent formulation for washing textiles) are utilized, the items treated therewith (in this case, a washed textile) are fragrant longer. What results from the invention is therefore a fragrance (impression) with a retarding effect, this fragrance retarding effect (i.e., the extension overtime of the fragrance impression) referring both to the particle and to objects containing the particle and to items treated with said objects.

It is greatly preferred according to the present invention that the carbon dioxide essentially does not form in the material to be (spray) dried essentially until said material is exposed to the hot drying-gas stream. The paste is therefore, by preference, substantially free of carbon dioxide before the paste is subjected to drying conditions.

In the case of spray drying, the drying-gas stream can be directed oppositely to the atomized materials or (which is preferred) can have the same direction of motion as the particles to be dried. According to the present invention, the temperature of the gas heating flow in the case of spray drying, upon entry into the relaxation space, is by preference at least 150° C.; advantageously, however, a temperature of 350° C. should not be exceeded, as already mentioned previously.

Drying, in particular spray drying, has proven successful not only in the manufacture of washing, cleaning, and care-providing agents, but also in the manufacture of a wide variety of other goods, for example foodstuffs such as dried milk, instant coffee, dried powdered yeast, eggs, or fruit juices, or other materials such as wood sugar, tanning agents, dried blood powder, polyvinyl and polyethylene powders, glue, sera, and also pharmaceutical preparations. The method according to the present invention is particularly suitable for the manufacture of all these goods, but in particular, of washing, cleaning, and care-providing agents, foodstuffs, luxury consumables, and pharmaceutical preparations. For foodstuffs and luxury consumables, a very high loading with aromas and essences can advantageously be achieved. For pharmaceutical preparations, a very high loading with essential oils or liquids, in particular of a hydrophobic nature, can advantageously be achieved.

In all cases, an increase in the loading capability with fragrances is attained, in which context the very good pouring properties of the particles are retained and the mechanical stability of the particles is also not degraded, and no change occurs in the fragrance note upon storage.

The method according to the present invention is most advantageous with regard to the manufacture of washing, cleaning, and care-providing agents, so that the paste to be processed according to the present invention by preference also encompasses one or more ingredients that can usually be contained in washing, cleaning, or care-providing agents. Such ingredients are described below.

It is also similarly preferred, however, when the pastes to be processed according to the present invention also encompass ingredients that are usually contained in foodstuffs and luxury consumables, pharmaceutical preparations, or other industrial (spray) dried goods. The relevant ingredients are based on the intended application of the particle, and are entrusted to one skilled in the art or may be inferred from pertinent reference works such as, for example, with regard to foods, the “Taschenbuch für Lebensmittelchemiker und-technologen” [Handbook for food chemists and technicians], Vols. 1 and 2, Wolfgang Frede, 1991, to the entirety of which reference is hereby made. It is surprising that in the context of foods and/or food components that are manufactured by means of the method according to the present invention, the aroma lasts longer than usual after application thereof. Thus, not only is it possible to introduce larger quantities of aroma without impairing the secondary particle properties such as mechanical stability or pourability, but the aroma that is introduced is also perceptible for a longer time.

According to a preferred embodiment of the invention, the paste to be processed according to the present invention contains organic carrier materials as known from the existing art, in particular, in connection with washing and cleaning agents.

According to a further preferred embodiment of the invention, the paste to be processed according to the present invention contains inorganic carrier material, selected by preference from the group encompassing zeolites, sulfates, carbonates, silicates, silicic acid, and/or mixtures thereof. Preferred combinations of these carrier materials are, in this context, the following:

zeolite-sulfate, zeolite-sulfate-carbonate, zeolite-sulfate-carbonate-silicate, zeolite-sulfate-carbonate-silicate-silicic acid, zeolite-carbonate, zeolite-carbonate-silicate, zeolite-carbonate-silicate-silicic acid, zeolite-silicate, zeolite-silicate-sulfate, zeolite-silicate-carbonate, zeolite-silicate-silicic acid, zeolite-silicic acid, zeolite-silicic acid-sulfate, zeolite-silicic acid-carbonate, sulfate-carbonate, sulfate-carbonate-silicate, sulfate-carbonate-silicate-silicic acid, sulfate-silicate, sulfate-silicic acid, carbonate-silicate, carbonate-silicic acid. In a further preferred embodiment, the inorganic carrier material contained in the paste is correspondingly made up of at least 30 wt %, by preference, at least 40 wt %, in particular, at least 60 wt % zeolite, by preference, zeolite X, Y, A, MAP, and/or mixtures thereof, based on the totality of the carrier material content.

According to a further preferred embodiment of the invention, the paste to be processed according to the present invention contains both organic and inorganic carrier material.

The zeolite usable according to the present invention is advantageously zeolite A and/or P. Zeolite MAP® (commercial product of the Crosfield Co.) is used, for example, as zeolite P. Y-type zeolite is also preferred. Also preferred are, for example, zeolite A as well as mixtures of A, X, and/or P, for example, a co-crystal of zeolites A and X (VEGOBOND AX®, a commercial product of Condea Augusta S.p.A.).

Zeolites preferred for use according to the present invention, such as the aforesaid, are further described below. Particularly suitable zeolites are zeolites of the faujasite type. Together with zeolites X and Y, the mineral faujasite is among the faujasite types within zeolite structural group 4, which are characterized by the D6R double six-membered ring subunit (cf, Donald W. Breck: “Zeolite Molecular Sieves,” John Wiley & Sons, New York, London, Sydney, Toronto, 1974, page 92). Also belonging to zeolite structural group 4, in addition to the aforesaid faujasite types, are the minerals chabazite and gmelinite, as well as the synthetic zeolites R (chabazite type), S (gmelinite type), L, and ZK-5. The latter two synthetic zeolites have no mineral analogs.

Zeolites of the faujasite type are constructed from β-cages that are tetrahedrally linked via D6R subunits, the β-cages being arranged similarly to the carbon atoms in diamonds. The three-dimensional network of the zeolites of the faujasite type that are suitable according to the present invention have pores of 2.2 and 7.4 Å; the elementary cells moreover contain eight cavities approximately 13 Å in diameter and can be described by the formula Na₈₆[(AIO₂)₈₆(SiO2)₁₀₆].264H₂O. The network of zeolite X contains a cavity volume of approximately 50%, based on the dehydrated crystal, which represents the largest empty space of all known zeolites (zeolite Y: approximately 48% cavity volume; faujasite: approximately 47% cavity volume). (All data from: Donald W. Breck: “Zeolite Molecular Sieves”, John Wiley & Sons, New York, London, Sydney, Toronto, 1974, pp. 145, 176, 177.)

In the context of the present invention, the term “zeolite of the faujasite type” characterizes all three zeolites that constitute the faujasite subgroup of zeolite structural group 4. In addition to zeolite X, zeolite Y and faujasite, as well as mixtures of those compounds, are also suitable according to the present invention, pure zeolite X being preferred.

Mixtures of co-crystals of zeolites of the faujasite type with other zeolites, which need not necessarily belong to zeolite structural group 4, are also suitable according to the present invention, at least 50 wt % of the zeolites being by preference of the faujasite type.

The suitable aluminum silicates are obtainable commercially, and the methods for their presentation are described in standard monographs.

Examples of commercially obtainable zeolites of the X type can be described by the following formulas:

Na₈₆[(AIO₂)₈₆(SiO₂)₁₀₆].x H₂O,

K₈₆[(AIO₂)₈₆(SiO₂)₁₀₆].x H₂O,

Ca₄₀Na₆[(AIO₂)₈₆(SiO₂)₁₀₆].x H₂O,

Sr₂₁Ba₂₂[(AIO₂)₈₆(SiO₂)₁₀₆].x H₂O,

in which x can assume values from greater than 0 to 276. These zeolites have pore sizes from 8.0 to 8.4 Å.

Also suitable, for example, is the zeolite A-LSX described in European Patent Application EP-A-816 291, which corresponds to a co-crystal of zeolite X and zeolite A and possesses in its anhydrous form the formula (M_{2/n}O+M′_{2/n}O). Al₂O₃.zSiO₂, in which M and M′ can be alkali or alkaline-earth metals and z is a number from 2.1 to 2.6. This product is commercially obtainable from CONDEA Augusta S.p.A under the brand name VEGOBOND AX.

Zeolites of the Y type are also commercially obtainable and can be described, for example, by the formulas

Na₅₆[(AIO₂)₅₆(SiO₂)₁₃₆].x H₂O,

K₅₆[(AIO₂)₅₆(SiO₂)₁₃₆].X H₂O,

in which x denotes numbers from greater than 0 to 276. These zeolites have pore sizes of 8.0 Å.

The particles sizes of the suitable zeolites of the faujasite type are in the range from 0.1 μm to 100 μm, by preference from 0.5 μm to 50 μm, and in particular from 1 μm to 30 μm, measured in each case using standard particle size determination methods.

The silicates, in particular amorphous silicates and crystalline sheet silicates, are also preferred.

Carrier materials according to the present invention are also, in particular, sheet-form sodium silicate of the general formula NaMSiₓO₂ₓ₊₁.y H₂O, where M denotes sodium or hydrogen, x is a number from 1.6 to 4, preferably from 1.9 to 4, and y denotes a number from 0 to 20, and preferred values for x are 2, 3, or 4. Because, however, crystalline silicates of this kind at least partially lose their crystalline structure in a spray-drying method, crystalline silicates are by preference subsequently mixed into the direct or post-treated product of spray drying. Crystalline sheet silicates of this kind are described, for example, in European Patent Application EP-A-0 164 514. Preferred crystalline sheet-form silicates of the formula indicated are those in which M denotes sodium and x assumes the value 2 or 3. In particular, both β- and δ-sodium disilicates Na₂Si₂O₅.y H₂O are preferred. Compounds of this kind are on the market, for example, under the designation SKS® (Clariant Co.), SKS-6®, for example, is predominantly a δ-sodium disilicate having the formula Na₂Si₂O₅.y H₂O, and SKS-7® is predominantly the β-sodium disilicate. When reacted with acids (e.g. citric acid or carbonic acid), the δ-sodium disilicate yields kanemite NaHSi₂O₅.y H₂O, available commercially under the designations SKS-9® and SKS-10® (Clariant). It may also be advantageous to institute chemical modifications of these sheet-form silicates. For example, the alkalinity of the sheet-form silicates can be influenced in suitable fashion. Sheet-form silicates doped with phosphate or carbonate have crystal morphologies that are modified as compared with the δ-sodium disilicate, dissolve more quickly, and exhibit an elevated calcium binding capability as compared with δ-sodium disilicate. Sheet-form silicates of the general empirical formula x Na₂O.y SiO₂.z P₂O₅, in which the ratio of x to y corresponds to a number from 0.35 to 0.6, the ratio of x to z to a number from 1.75 to 1,200, and ratio of y to z to a number from 4 to 2,800, are described, e.g., in Patent Application DE-A-196 01 063. The solubility of the sheet-form silicates can also be enhanced by using especially finely particulate sheet-form silicates. Compounds of the crystalline sheet-form silicates with other ingredients can also be used. Particularly to be mentioned are compounds with cellulose derivatives, which exhibit advantages in terms of disintegrating effect, as well as compounds with polycarboxylates, e.g., citric acid, or polymeric polycarboxylates, e.g., copolymers of acrylic acid.

The preferred carrier materials also include amorphous sodium silicates having a Na₂O:SiO₂ modulus of 1:2 to 1:3.3, by preference, 1:2 to 1:2.8, and in particular, 1:2 to 1:2.6, which are dissolution-delayed and exhibit secondary washing properties. The dissolution delay as compared with conventional amorphous sodium silicates can have been brought about in various ways, for example, by surface treatment, compounding, compacting/densification, or overdrying. In the context of this invention, the term “amorphous” is also understood to mean “X-amorphous.” In other words, in X-ray diffraction experiments the silicates yield not the sharp X-ray reflections that are typical of crystalline substances, but at most one or more maxima in the scattered X radiation that have a width of several degree units of the diffraction angle, It can be advantageous if the silicate particles yield blurred or even sharp diffraction maxima in electron beam diffraction experiments, This may be interpreted to mean that the products have microcrystalline regions 10 to several hundred nm in size, values of up to a maximum of 50 nm, and in particular, a maximum of 20 nm, being preferred. So-called X-amorphous silicates of this kind, which likewise exhibit a dissolution delay as compared with conventional water glasses, are described, e.g., in German Patent Application DE-A-44 00 024. Densified/compacted amorphous silicates, compounded amorphous silicates, and overdried X-amorphous silicates are particularly preferred. Suitable carrier materials further include sheet silicates of natural and synthetic origin. Such sheet silicates are known, for example, from Patent Applications DE-B-23 34 899, EP-A-0 026 529, and DE-A-35 26 405. Their usability is not limited to one specific composition or structural formula. Smectites, in particular, bentonites, are, however, preferred here.

Sheet silicates usable as a carrier material that belong to the group of the water-swellable smectites are, for example, montmorillonite, hectorite, or saponite. In addition, small quantities of iron can be incorporated into the crystal lattice of the sheet silicates according to the formulas above. Furthermore, because of their ion-exchanging properties, the sheet silicates can contain hydrogen, alkali, and alkaline-earth ions, in particular Na⁺ and Ca²⁺. The quantity of water of hydration is usually in the range from 8 to 20 wt %, and depends on the swelling state or the type of processing. Usable sheet silicates are known, for example, from U.S. Pat. No. 3,966,629, EP-A-0 026 529, and EP-A-0 028 432. It is preferable to use sheet silicates that, as a result of an alkaline treatment, are largely free of calcium ions and strongly color-imparting iron ions.

Particularly preferred carrier materials are alkali-metal carbonates and alkali-metal hydrogencarbonates, sodium and potassium carbonate and, in particular, sodium carbonate being among the preferred embodiments.

Particularly preferred carrier materials are also the sulfates, by preference alkali-metal and alkaline-earth metal sulfates, sodium and magnesium sulfate being distinctly preferred.

Particularly preferred carrier materials are also the silicic acids, by preference, the precipitated silicic acids, in particular, the silica gels, which advantageously are hydrophobic or hydrophilic.

It has been found that slurries of this kind containing aforesaid carrier materials result, in the method according to the present invention, in particularly perfume-absorptive particles whose stability and pourability are very high; not only can they absorb large quantities of perfume, but the perfume effect in them also lasts for a longer time.

It has been observed that the decomposition of fragrances in the particles manufactured according to the present invention is greatly slowed as compared with comparable particles. Even when the particles according to the present invention are incorporated into highly alkaline matrices, the fragrances contained in the particle are surprisingly stable. It is easily possible to incorporate the particles according to the present invention, which can be loaded with large quantities of fragrances, into other agents such as, for example, washing and cleaning agents, without a gas-tight encasing layer. Because the particles according to the present invention loaded with fragrances are moreover free-flowing and do not clump, incorporation into washing and cleaning agents or comparable agents occurs without difficulty.

The paste to be processed according to the present invention can, by preference, also contain nonionic surfactant, which corresponds to a preferred embodiment of the invention. The nonionic surfactant is, according to a further preferred embodiment of the invention, selected from the group of the alkoxylated alcohols, the alkylphenol polyglycol ethers, the alkoxylated fatty acid alkyl esters, the polyhydroxy fatty acid amides, the alkyl glycosides, the alkyl polyglucosides, the amine oxides, and/or the long-chain alkylsulfoxides.

Nonionic surfactants are, however, by preference, present only in subordinate quantities in the direct products of (spray) drying. For example, their concentration can be up to 2 or 3 wt %. According to a further preferred embodiment of the invention, the directly dried, in particular, directly spray-dried products, are, in fact, free, of nonionic surfactants, i.e. contain less than 1 wt %, by preference less than 0.5 wt %, and, in particular, no nonionic surfactant at all. For a more accurate description of the nonionic surfactants, the reader is referred to the description below of the post-treated products of (spray) drying.

It has been possible, surprisingly, to establish that the presence of nonionic surfactant in the paste, in particular, in subordinate quantities, results in a further enhancement of the absorption capacity of the particles resulting from the method according to the present invention. Advantageously, however, the absorption capacity of the particles is significantly higher when nonionic surfactant is applied in a post-treatment step onto the direct product of (spray) drying.

When nonionic surfactant is contained in the paste, then according to a further preferred embodiment of the invention, alkoxylated alcohol is contained at least in part as a nonionic surfactant, by preference, in quantities of at least 40 wt %, advantageously, at least 50 wt %, with further advantage, at least 60 wt %, with great advantage, at least 70 wt %, even more advantageously, at least 80 wt %, in particular, at least 90 wt %, most advantageously, in quantities of 100 wt %, based in each case on the total quantity of nonionic surfactant contained in the paste, the alcohols being advantageously ethoxylated, in particular, primary alcohols having by preference 8 to 18, in particular, 12 to 18 C atoms and by preference, an average of 1 to 12 mol alkylene oxide, by preference, ethylene oxide, per mol of alcohol.

According to a further preferred embodiment of the invention, the paste contains anionic or cationic surfactant, by preference, in small quantities, advantageously in quantities of less than 10 wt %, by preference, less than 8 wt %, in particular, less than 5 wt %, based on the paste. The use of such a small quantity of anionic or cationic surfactant makes it possible further to enhance the perfume loading capability of the resulting particles. The resulting particles are nevertheless free-flowing and do not clump. The perfume is stabilized in the particles, and decomposition of the fragrances does not occur or is very greatly delayed. Particularly suitable anionic or cationic surfactants are described below.

A further subject of the invention is a particle that can be manufactured according to a method according to the present invention, the particle of the direct product of (spray) drying being post-treated. The particle resulting directly from the method according to the present invention is referred to as a particle of the direct product of (spray) drying. Such a particle can be post-treated according to the present invention, which is advantageous. The post-treatment can be accomplished both with solid and with flowable or sprayable substances, or in combined fashion. Post-treatment with solid substances is to be understood, for example, as dusting of the particle with very finely particulate substances. Post-treatment with flowable or sprayable substances is to be understood, for example, as impregnation (by preference, soaking) of the particle with a liquid such as, for example, perfume. Post-treatment by preference occurs first with the liquid and then with the solid substances. “Post-treatment” is also to be understood as mechanical rounding of the particle.

Post-treatment by rounding represents an action preferred according to the present invention. Rounding of the direct product of (spray) drying can be accomplished in an ordinary rounding machine. The rounding time in this context is by preference no longer than 4 minutes, in particular, no longer than 3.5 minutes. Rounding times of a maximum of 1.5 minutes or less are particularly preferred. A further homogenization of the particle-size spectrum is achieved by rounding.

The direct product of (spray) drying manufactured according to the present invention can advantageously be post-treated prior to (optional) rounding, in particular with nonionic surfactants and perfume or preparation forms that contain these ingredients, by preference with quantities of up to 40 wt % active substance, in particular with quantities from 2 to 35 wt % active substance, based in each case on the post-treated product, in a manner that is usual per se, by preference in a mixer or, if applicable, a fluidized bed. It is preferable if the direct product of (spray) drying is first impregnated with nonionic surfactant and thereafter loaded with perfume. The direct product of (spray) drying can, however, of course, also be loaded immediately with perfume, i.e., impregnation with nonionic surfactant is omitted. The direct product of (spray) drying can likewise also be post-treated with a preparation that is a mixture of nonionic surfactant and perfume and, if applicable, further constituents.

According to a preferred embodiment of the invention, the particle manufactured according to the present invention is post-treated with nonionic surfactants and/or perfume, or with preparation forms that contain these ingredients.

The nonionic surfactant is by preference selected from the group of the alkoxylated alcohols, the alkylphenol polyglycol ethers, the alkoxylated fatty acid alkyl esters, the polyhydroxy fatty acid amides, the alkyl glycosides, the alkyl polyglucosides, the amine oxides, and/or the long-chain alkylsulfoxides.

It is further preferred that the nonionic surfactant used for post-treatment encompass alkoxylated alcohol, this referring advantageously to ethoxylated, in particular, primary alcohols having by preference 8 to 18, in particular 12 to 18 C atoms, and by preference an average of 1 to 12 mol alkylene oxide, by preference ethylene oxide, per mol of alcohol.

In particular, the direct product of (spray) drying manufactured according to the present invention can be post-treated, i.e., dusted, by preference after (optional) rounding and/or (optional) post-treatment with pourable or sprayable substances, with solid materials, by preference in quantities up to 15 wt %, in particular, in quantities from 2 to 15 wt %, based in each case on the total weight of the post-treated agent. Unexpectedly, however, the particles manufactured according to the present invention are not tacky even when they contain a high loading level of perfume or the like, so that dusting can even, advantageously, be entirely omitted.

Solid materials that can be used for dusting are, by preference, hydrogencarbonate, carbonate, zeolite, silicic acid, citrate, urea, or mixtures thereof, in particular in quantities from 2 to 15 wt % based on the total weight of the post-treated product. The post-treatment can advantageously be performed in a mixer and/or by means of a rounding machine.

In a preferred post-treatment step, it is possible to dust the direct product of (spray) drying with a solid material, for example silicic acids, zeolites, carbonates, hydrogencarbonates and/or sulfates, citrates, urea, or mixtures of two or more of the aforesaid substances. This can be accomplished either in a mixer directly after the direct product of spray drying leaves the tower, or in the rounding machine.

In a very preferred embodiment of the invention, the direct product of (spray) drying is post-treated with nonionic surfactants that, for example, can also contain optical brighteners and/or hydrotropes, and with perfume, or with preparation forms that can contain these ingredients. Advantageously in this context, post-treatment occurs first with the nonionic surfactants and only then with the perfume. By preference, these ingredients or preparation forms that contain these ingredients are applied in liquid, melted, or pasty form onto the direct product of (spray) drying. Advantageously, the direct products of (spray) drying are post-treated with up to 40 wt % active substance of the aforesaid ingredients. The quantitative indication is based on the post-treated product. It is preferable in this context for the post-treatment with the substances recited here to be accomplished in a usual mixer. Products post-treated in this fashion can have a bulk weight from 300 to 1,000 g/l, by preference from 450 to 850 g/l, in particular from 500 to 750 g/l.

It is surprising and unexpected that the pourability of the product is not impaired by such actions. Proceeding from a direct product of (spray) drying, the pouring capability remains substantially constant even when said product is post-treated with, for example, up to 35 wt % (based on the post-treated product) nonionic surfactant and perfume.

According to a preferred embodiment of the invention, nonionic surfactant is therefore conveyed to the direct product of (spray) drying in the course of post-treatment.

It is preferable to use alkoxylated, advantageously ethoxylated, in particular, primary alcohols having preferably 8 to 18 C atoms and an average of 1 to 12 mol ethylene oxide (EO) per mol of alcohol, in which the alcohol radical can be linear or preferably methyl-branched in the 2-position, or can contain mixed linear and methyl-branched radicals, such as those that are usually present in oxo alcohol radicals. Particularly preferred, however, are alcohol ethoxylates having linear radicals made up of alcohols of natural origin having 12 to 18 C atoms, e.g., coconut, palm, tallow, or oleyl alcohol, and an average of 2 to 8 EO per mol of alcohol. The preferred ethoxylated alcohols include, for example, C₁₂₋₁₄ alcohols with 3 EO or 4 EO, C₉₋₁₁ alcohol with 7 EO, C₁₃₋₁₅ alcohols with 3 EO, 5 EO, 7 EO, or 8 EO, C₁₂₋₁₈ alcohols with 3 EO, 5 EO, or 7 EO, and mixtures thereof, such as mixtures of C₁₂₋₁₄ alcohol with 3 EO and C₁₂₋₁₈ alcohol with 7 EO. The degrees of ethoxylation indicated represent statistical averages, which can correspond to an integer or a fraction for a specific product. Preferred alcohol ethoxylates exhibit a narrow distribution of homologs (narrow range ethoxylates, NRE). In addition to these nonionic surfactants, fatty alcohols with more than 12 EO can also be used. Examples of these are (tallow) fatty alcohols with 14 EO, 16 EO, 20 EO, 25 EO, 30 EO, or 40 EO.

It has been found, surprisingly, that the alkoxylated alcohols specifically are very advantageous for further maximizing the perfume absorption capability of the particles, favoring the stability of the perfume in the particle, and promoting the aforesaid fragrance-retarding effect as well as the fragrance-intensifying effect.

According to a further preferred embodiment, nonionic surfactants that are particularly suitable for post-treatment are a mixture of at least two different nonionic surfactants, by preference of two different alkoxylated, advantageously ethoxylated, in particular primary alcohols, the distinguishing feature in terms of the alkoxylated alcohols being by preference the degree of alkoxylation.

If there is present, in this mixture of at least two different nonionic surfactants, at least one alkoxylated, by preference ethoxylated alcohol having a degree of alkoxylation less than 7, advantageously no greater than 6, with further advantage no greater than 5, in particular no greater than 4.5, and at least one further alkoxylated, advantageously ethoxylated alcohol having a degree of alkoxylation of at least 7, this is then a further preferred embodiment of the invention.

According to a further preferred embodiment of the invention, the ratio of lower alkoxylated alcohol to higher alkoxylated alcohol is in the range from 5:1 to 1:5, by preference, 4:1 to 1:4, advantageously, 3:1 to 1:3, in particular, 2:1 to 1:2.

Preferably, however, it is also possible to use alkyl glycosides of the general formula RO(G)ₓ, in which R denotes a primary straight-chain or methyl-branched (in particular methyl-branched in the 2-position) aliphatic radical having 8 to 22, preferably 12 to 18 C atoms; and G is the symbol denoting a glucose unit having 5 or 6 C atoms, preferably glucose. The degree of oligomerization x, which indicates the distribution of monoglycosides and oligoglycosides, is any number between 1 and 10; x is by preference between 1.1 and 1.4.

A further class of nonionic surfactants used in preferred fashion, which are used either as the only nonionic surfactant or in combination with other nonionic surfactants, in particular, together with alkoxylated fatty alcohols and/or alkyl glycosides, is alkoxylated, preferably ethoxylated or ethoxylated and propoxylated, fatty acid alkyl esters, by preference having 1 to 4 carbon atoms in the alkyl chain, in particular, fatty acid methyl esters such as those described, for example, in Japanese Patent Application HP 58/217598, or that are manufactured, by preference, according to the method described in International Patent Application WO-A-90/13533. C₁₂-C₁₈ fatty acid methyl esters having an average of 3 to 15 EO, in particular, an average of 5 to 12 EO, are particularly preferred.

Nonionic surfactants of the amine oxide type, for example N-cocalkyl-N,N-dimethylamine oxide and N-tallowalkyl-N,N-dihydroxyethylamine oxide, and the fatty acid alkanolamides, can also be suitable. The quantity of these nonionic surfactants is by preference no more than that of the ethoxylated fatty alcohols, in particular, no more than half thereof.

According to a preferred embodiment, alkoxylated alcohol is used as a nonionic surfactant in the context of post-treatment, by preference in quantities of at least 40 wt %, advantageously at least 50 wt %, with further advantage at least 60 wt %, with great advantage at least 70 wt %, even more advantageously at least 80 wt %, in particular at least 90 wt %, most advantageously in quantities of 100 wt %, based in each case on the total quantity of nonionic surfactant that is delivered in the course of post-treatment.

According to a further preferred embodiment, a particle according to the present invention contains carrier material, by preference inorganic carrier material, in a total quantity of at least 30 wt % based on the entire particle, perfume that is adsorbed/absorbed onto/into the carrier material, as well as at least 0.1 wt % nonionic surfactant, based on the entire post-treated particle.

According to a further preferred embodiment, the quantity of perfume absorbed/adsorbed into/onto the carrier material of a particle according to the present invention is at least 1 wt %, by preference at least 5 wt %, advantageously more than 10 wt %, with further advantage more than 15 wt %, with further advantage more than 20 wt %, in particular more than 25 wt %, based on the entire post-treated particle.

Further conceivable additives, in particular for post-treatment of the products, are foam inhibitors such as, for example, foam-inhibiting paraffin oil or foam-inhibiting silicone oil, for example dimethylpolysiloxane. The use of mixtures of these active substances is also possible. Suitable additives that are solid at room temperature, especially in the context of the aforesaid foam-inhibiting active substances, are paraffin waxes, silicic acids that can also be hydrophobized in known fashion, and bisamides derived from C₂₋₇ diamines and C₁₂₋₂₂ carboxylic acids.

Foam-inhibiting paraffin oils appropriate for use, which can be present in an admixture with paraffin waxes, generally represent complex substance mixtures having no well-defined melting point. For characterization, it is usual to determine the melting range by differential thermal analysis (DTA), as described in “The Analyst” 87 (1962), 420, and/or the solidification point. This is understood as the temperature at which the paraffin transitions, as a result of slow cooling, from the liquid into the solid state. Paraffins having fewer than 17 C atoms are less usable according to the present invention; their concentration in the paraffin oil mixture should therefore be as low as possible, and is by preference below the limit significantly measurable with ordinary analytical methods, e.g., gas chromatography. It is preferable to use paraffins that solidify in the range from 20° C. to 70° C. It should be noted that even paraffin wax mixtures that appear solid at room temperature can contain different proportions of liquid paraffin oils. For the paraffin waxes usable according to the present invention, the liquid proportion at 40° C. is as high as possible without already amounting to 100% at that temperature. Preferred paraffin wax mixtures have a liquid proportion of at least 50 wt %, in particular 55 wt % to 80 wt %, at 40° C., and a liquid proportion of at least 90 wt % at 60° C. The consequence of this is that the paraffins are flowable and pumpable at temperatures down to at least 70° C., by preference down to at least 60° C. Care must moreover be taken to ensure that the paraffins contain as few volatile components as possible. Preferred paraffin waxes contain less than 1 wt %, in particular less than 0.5 wt %, of components that are evaporable at 110° C. and standard pressure. Paraffins usable according to the present invention can be obtained, for example, under the commercial designations Lunaflex® of the Fuller company and Deawax® of DEA Mineralöl AG.

The paraffin oils can contain bisamides that are solid at room temperature, and that derive from saturated fatty acids having 12 to 22, by preference 14 to 18 C atoms, and from alkylenediamines having 2 to 7 C atoms. Suitable fatty acids are lauric, myristic, stearic, arachidic and behenic acid, as well as mixtures thereof, such as those obtainable from natural fats or hardened oils, such as tallow or hydrogenated palm oil. Suitable diamines are, for example, ethylenediamine-1,3-propylenediamine, tetramethylenediamine, pentamethylenediamine, hexamethylenediamine, p-phenylenediamine, and toluylenediamine. Preferred diamines are ethylenediamine and hexamethylenediamine. Particularly preferred bisamides are bismyristoylethylenediamine, bispalmitoylethylenediamine, bisstearoylethylenediamine, and mixtures thereof, as well as the corresponding derivatives of hexamethylenediamine.

In accordance with a further embodiment of the invention, the aforesaid foam inhibitors can also be contained in the direct product of (spray) drying.

According to a further preferred embodiment, a preferably post-treated particle according to the present invention contains
a) carrier material, by preference inorganic carrier material, in quantities of at least 30 wt %, advantageously in quantities from 50 to 95 wt %, by preference 60 to 90 wt %,
b) perfume in quantities from 0.5 to 40 wt %, by preference 1 to 35 wt %,
c) nonionic surfactant in quantities from 0.1 to 30 wt %, by preference 0.5 to 10 wt %, in particular 1 to 5 wt %,
   as well as, optionally, further constituents.

The further constituents can advantageously be typical ingredients of washing and cleaning agents. Particles that can be manufactured according to the present invention, which are provided, in particular, for use in or as washing and cleaning agents, can contain typical ingredients, selected, in particular, from the group encompassing substances having washing, care-providing, and/or cleaning activity such as surfactants, builder substances, bleaching agents, bleach activators, bleach stabilizers, bleach catalysts, enzymes, polymers co-builders, alkalizing agents, acidifying agents, antiredeposition agents, silver protection agents, coloring agents, optical brighteners, UV protection substances, conditioners and/or clear rinses, and if applicable further constituents, which are described in further detail below. The ingredients described, and all further suitable usual ones, can be contained directly in the product of (spray) drying, but by preference can also be applied onto the particles in the course of a post-treatment. The particles can likewise be mixed together with components that contain such ingredients and/or other usual ones.

The anionic surfactants used are by preference those of the sulfonate and sulfate types. Possibilities as surfactants of the sulfonate type are, by preference, C₉₋₁₃ alkyl benzenesulfonates, olefinsulfonates, i.e. mixtures of alkene- and hydroxyalkanesulfonates, and disulfonates, for example, such as those obtained from C₁₂₋₁₈ monoolefins having an end-located or internal double bond, by sulfonation with gaseous sulfur trioxide and subsequent alkaline or acid hydrolysis of the sulfonation products. Also suitable are alkanesulfonates that are obtained from C₁₂₋₁₈ alkanes, for example, by sulfochlorination or sulfoxidation with subsequent hydrolysis and neutralization. The esters of α-sulfo fatty acids (estersulfonates), e.g. the α-sulfonated methyl esters of hydrogenated coconut, palm kernel, or tallow fatty acids, are likewise suitable.

Further suitable anionic surfactants are sulfonated fatty acid glycerol esters. “Fatty acid glycerol esters” are understood as the mono-, di- and triesters, and mixtures thereof, that are obtained during the production by esterification of a monoglycerol with 1 to 3 mol fatty acid, or upon transesterification of triglycerides with 0.3 to 2 mol glycerol. Preferred sulfonated fatty acid glycerol esters are the sulfonation products of saturated fatty acids having 6 to 22 carbon atoms, for example hexanoic acid, octanoic acid, decanoic acid, myristic acid, lauric acid, palmitic acid, stearic acid, or behenic acid.

Preferred alk(en)yl sulfates are the alkali, and in particular sodium salts of the sulfuric acid semi-esters of the C₁₂-C₁₈ fatty alcohols, for example, from coconut fatty alcohol, tallow fatty alcohol, lauryl, myristyl, cetyl, or stearyl alcohol, or the C₁₀-C₂₀ oxo alcohols, and those semi-esters of secondary alcohols of those chain lengths. Additionally preferred are alk(en)yl sulfates of the aforesaid chain length that contain a synthetic straight-chain alkyl radical produced on a petrochemical basis, which possess a breakdown behavior analogous to those appropriate compounds based on fat-chemistry raw materials. For purposes of washing technology, the C₁₂₋C₁₆ alkyl sulfates and C₁₂-C₁₅ alkyl sulfates, as well as C₁₄-C₁₅ alkyl sulfates, are preferred. 2,3-alkyl sulfates that can be obtained, as commercial products of the Shell Oil Company, under the name DAN®, are also suitable anionic surfactants.

The sulfuric acid monoesters of straight-chain or branched C₇₋₂₁ alcohols ethoxylated with 1 to 6 mol ethylene oxide, such as 2-methyl-branched C₉₋₁₁ alcohols with an average of 3.5 mol ethylene oxide (EO) or C₁₂₋₁₈ fatty alcohols with 1 to 4 EO, are also suitable. Because of their high foaming characteristics they are used in cleaning agents only in relatively small quantities, for example, in quantities from 1 to 5 wt % based on the entire agent, in particular cleaning agent.

Other suitable anionic surfactants are also the salts of alkylsulfosuccinic acid, which are also referred to as sulfosuccinates or as sulfosuccinic acid esters and represent the monoesters and/or diesters of sulfosuccinic acid with alcohols, preferably fatty alcohols, and, in particular, ethoxylated fatty alcohols. Preferred sulfosuccinates contain C₈₋₁₈ fatty alcohol radicals or mixtures thereof. Particularly preferred sulfosuccinates contain a fatty alcohol radical that is derived from ethoxylated fatty alcohols which, considered per se, represent nonionic surfactants (see below for description), Sulfosuccinates whose fatty alcohol radicals derive from ethoxylated fatty alcohols having a restricted homolog distribution are, in turn, particularly preferred. It is likewise also possible to use alk(en)yl succinic acid having by preference 8 to 18 carbon atoms in the alk(en)yl chain, or salts thereof.

The concentration of the aforesaid anionic surfactants in the agents, by preference washing and cleaning agents, that contain the particles according to the present invention, in particular the post-treated products of (spray) drying, is by preference 2 to 30 wt % and in particular 5 to 25 wt %, concentrations above 10 wt % and even above 15 wt % being especially preferred, based in each case on the entire agent. The particle according to the present invention as such, in particular the post-treated product of (spray) drying, on the other hand, by preference contains only small quantities of anionic surfactant, advantageously less than 10 wt %, with further advantage less than 8 wt %, by preference less than 5 wt %, and in particular 1 to 4 wt %, based on the particle according to the present invention, in particular the post-treated product of (spray) drying.

Soaps can additionally be contained. Saturated fatty acid soaps, such as the salts of lauric acid, myristic acid, palmitic acid, stearic acid, hydrogenated erucic acid, and behenic acid, are suitable, as are soap mixtures derived in particular from natural fatty acids, e.g., coconut, palm kernel, or tallow fatty acids. The soap content of the particles according to the present invention, in particular, the post-treated products of (spray) drying, is by preference no more than 3 wt % and in particular 0.5 to 2.5 wt %, based on the entire particle, in particular, the post-treated product of (spray) drying.

The anionic surfactants and soaps can be present in the form of their sodium, potassium, or ammonium salts, and as soluble salts of organic bases, such as mono-, di-, or triethanolamine. They are by preference present in the form of their sodium or potassium salts, in particular, in the form of the sodium salts. Anionic surfactants and soaps can also be produced in situ, by introducing into the composition to be (spray) dried the anionic surfactant acids and, if applicable, fatty acids, which are then neutralized by the alkali carriers in the composition to be (spray) dried.

Carriers according to the present invention such as zeolites or silicates act, for example, as builders. In addition to the carriers having a builder effect, further builders can be contained.

Phosphates can also be used in cases in which a phosphate content is tolerated, in particular, pentasodium triphosphate, if applicable, also pyrophosphates and orthophosphates, which act principally as precipitating agents for lime salts. Phosphates are used predominantly in automatic dishwashing agents, but in some cases also in washing agents.

“Alkali-metal phosphates” is the summary designation for the alkali-metal (in particular sodium and potassium) salts of the various phosphoric acids, in which context a distinction can be made between metaphosphoric acids (HPO₃)ₙ and orthophosphoric acid H₃PO₄, in addition to higher-molecular-weight representatives. The phosphates offer a combination of advantages: they act as alkali carriers, prevent lime deposits on machine parts and lime encrustations in fabrics, and furthermore contribute to cleaning performance.

Sodium dihydrogenphosphate, NaH₂PO₄, exists as the dihydrate (density 1.91 gcm⁻³, melting point 60° C.) and as the monohydrate (density 2.04 gcm⁻³). Both salts are white powders that are very easily soluble in water and that lose their water of crystallization upon heating and transition at 200° C. into the weakly acid diphosphate (disodium hydrogendiphosphate, Na₂H₂P₂O₇), and at higher temperature into sodium trimetaphosphate (Na₃P₃O₉) and Maddrell salt (see below). NaH₂PO₄ reacts in acid fashion; it is created when phosphoric acid is adjusted with sodium hydroxide to a pH of 4.5 and the mash is spray-dried. Potassium dihydrogenphosphate (primary or unibasic potassium phosphate, potassium diphosphate, KDP), KH₂PO₄, is a white salt of density 2.33 gcm⁻³, has a melting point of 253° [decomposing to form potassium polyphosphate (KPO₃)ₓ], and is easily soluble in water.

Disodium hydrogenphosphate (secondary sodium phosphate), Na₂HPO₄, is a colorless, very easily water-soluble crystalline salt. It exists anyhdrously and with 2 mol (density 2.066 gcm⁻³, water lost at 95° C.), 7 mol (density 1.68 gcm⁻³ melting point 48° C. with loss of 5H₂O), and 12 mol of water (density 1.52 gcm⁻³, melting point 35° C. with loss of 5H₂O); it becomes anhydrous at 100° C. and when further heated transitions into the diphosphate Na₄P₂O₇. Disodium hydrogenphosphate is produced by the neutralization of phosphoric acid with a soda solution using phenolphthalein as indicator. Dipotassium hydrogenphosphate (secondary or dibasic potassium phosphate), K₂HPO₄, is an amorphous white salt that is easily soluble in water.

Trisodium phosphate (tertiary sodium phosphate), Na₃PO₄, exists as colorless crystals that as the dodecahydrate have a density of 1.62 gcm⁻³ and a melting point of 73-76° C. (decomposition), as the decahydrate (corresponding to 19-20% P₂O₅) a melting point of 100° C., and in anhydrous form (corresponding to 39-40% P₂O₅) a density of 2.536 gcm⁻³. Trisodium phosphate is easily soluble in water with an alkaline reaction, and is produced by evaporating a solution of exactly 1 mol disodium phosphate and 1 mol NaOH. Tripotassium phosphate (tertiary or tribasic potassium phosphate), K₃PO₄, is a white, deliquescent, granular powder with a density of 2.56 gcm⁻³, has a melting point of 1,340° C., and is easily soluble in water with an alkaline reaction. It is produced, for example, upon heating of basic slag with carbon and potassium sulfate. Despite the higher price, the more easily soluble and therefore highly active potassium phosphates are greatly preferred over corresponding sodium compounds in the cleaning-agent industry.

Tetrasodium diphosphate (sodium pyrophosphate), Na₄P₂O₇, exists in anhydrous form (density 2.534 gcm⁻³, melting point 988° C., also indicated as 880° C.) and as the decahydrate (density 1.815-1.836 gcm⁻³, melting point 94° C. with loss of water). Both substances are colorless crystals that are soluble in water with an alkaline reaction. Na₄P₂O₇ is created when disodium phosphate is heated to >200° C., or by reacting phosphoric acid with soda in the stoichiometric ratio and dewatering the solution by spraying. The decahydrate complexes heavy-metal salts and hardness constituents, and therefore decreases water hardness. Potassium diphosphate (potassium pyrophosphate), K₄P₂O₇, exists in the form of the trihydrate and represents a colorless, hygroscopic powder with a density of 2.33 gcm⁻³ that is soluble in water, the pH of a 1% solution being 10.4 at 25° C.

Condensation of NaH₂PO₄ or KH₂PO₄ yields higher-molecular-weight sodium and potassium phosphates, within which a distinction can be made between cyclic representatives (the sodium and potassium metaphosphates) and chain types (the sodium and potassium polyphosphates). For the latter, in particular, a number of designations are in use: fused or thermal phosphates, Graham salt, Kurrol's salt, and Maddrell salt. All the higher sodium and potassium phosphates are together referred to as “condensed” phosphates.

The technically important pentasodium triphosphate Na₅P₃O₁₀ (sodium tripolyphosphate) is a colorless, water-soluble, non-hygroscopic salt, crystallizing anhydrously or with 6H₂O, of the general formula NaO—[P(O)(ONa)—O]ₙ—Na, where n=3. Approximately 17 g of the salt containing no water of crystallization dissolves in 100 g of water at room temperature, approximately 20 g at 60° C., and approximately 32 g at 100°; after the solution is heated to 100° C. for two hours, approximately 8% orthophosphate and 15% disphosphate are produced by hydrolysis. In the production of pentasodium triphosphate, phosphoric acid is reacted with a soda solution or sodium hydroxide in the stoichiometric ratio, and the solution is dewatered by spraying. Like Graham salt and sodium diphosphate, pentasodium triphosphate dissolves many insoluble metal compounds (including lime soaps, etc.). Pentapotassium triphosphate K₅P₃O₁₀ (potassium tripolyphosphate) is marketed, for example, in the form of a 50-wt % solution (>23% P₂O₅, 25% K₂O). The potassium polyphosphates are widely used in the washing- and cleaning-agent industry. Sodium potassium tripolyphosphates also exist and are likewise usable in the context of the present invention. They are produced, for example, when sodium trimetaphosphate is hydrolyzed with KOH:

(NaPO₃)₃+2KOH→Na₃K₂P₃O₁₀+H₂O

These are usable according to the present invention in just the same way as sodium tripolyphosphate, potassium tripolyphosphate, or mixtures of the two; mixtures of sodium tripolyphosphate and sodium potassium tripolyphosphate, or mixtures of potassium tripolyphosphate and sodium potassium tripolyphosphate, or mixtures of sodium tripolyphosphate and potassium tripolyphosphate and sodium potassium tripolyphosphate, are also usable according to the present invention.

Also usable as organic builder substances are, for example, the polycarboxylic acids usable in the form of their sodium salts, “polycarboxylic acids” being understood as those carboxylic acids that carry more than one acid function. These are, for example, citric acid, adipic acid, succinic acid, glutaric acid, malic acid, tartaric acid, maleic acid, fumaric acid, sugar acids, aminocarboxylic acids, nitrilotriacetic acid (NTA), provided such use is not objectionable for environmental reasons, as well as mixtures thereof. Preferred salts are the salts of the polycarboxylic acids such as citric acid, adipic acid, succinic acid, glutaric acid, tartaric acid, sugar acids, and mixtures thereof.

The acids per se can also be used. The acids typically also possess, in addition to their builder effect, the property of an acidifying component, and thus serve also to establish a lower and milder pH for washing or cleaning agents. Worthy of mention in this context are, in particular, citric acid, succinic acid, glutaric acid, adipic acid, gluconic acid, and any mixtures thereof.

Further suitable as builders are polymeric polycarboxylates; these are, for example, the alkali-metal salts of polyacrylic acid or polymethacrylic acid, for example those having a relative molecular weight from 500 to 70,000 g/mol.

The molar weights indicated for polymeric polycarboxylates are, for purposes of this document, weight-averaged molar weights M_{w} of the respective acid form that were determined in principle by means of gel permeation chromatography (GPC), a UV detector having been used. The measurement was performed against an external polyacrylic acid standard that, because of its structural affinity with the polymers being investigated, yields realistic molecular weight values. These indications deviate considerably from the molecular weight indications in which polystyrenesulfonic acids are used as a standard. The molar weights measured against polystyrenesulfonic acids are usually much higher than the molar weights indicated in this document.

Suitable polymers are, in particular, polyacrylates that preferably have a molecular weight from 1,000 to 20,000 g/mol. Because of their superior solubility, of this group the short-chain polyacrylates that have molar weights from 1,000 to 10,000 g/ml, and particularly preferably from 1,200 to 8,000 g/mol, for example 4,500 or 8,000, may in turn be preferred.

It is particularly preferred to use in the agents according to the present invention both polyacrylates and copolymers of unsaturated carboxylic acids, sulfonic acid group-containing monomers, and if applicable further ionic or nonionogenic monomers. The sulfonic acid group-containing copolymers are described in detail below.

Copolymeric polycarboxylates, in particular, those of acrylic acid with methacrylic acid and of acrylic acid or methacrylic acid with maleic acid, are also suitable. Copolymers of acrylic acid with maleic acid that contain 50 to 90 wt % acrylic acid and 50 to 10 wt % maleic acid have proven particularly suitable. Their relative molecular weight, based on free acids, is generally 2,000 to 100,000 g/mol, by preference 20,000 to 90,000 g/mol, and in particular 30,000 to 80,000 g/mol.

The (co)polymeric polycarboxylate content of the direct products of (spray) drying is by preference 0.5 to 20 wt %, in particular 2 to 20 wt %, contents of a maximum of 10 wt % being especially well received for cost reasons.

To improve water solubility, the polymers can also contain allylsulfonic acids, for example, allyloxybenzenesulfonic acid and methallylsulfonic acid, as monomers.

Also particularly preferred are biodegradable polymers made up of more than two different monomer units, for example, those that contain salts of acrylic acid and of maleic acid, as well as vinyl alcohol or vinyl alcohol derivatives, as monomers, or that contain salts of acrylic acid and of 2-alkylallylsulfonic acid, as well as sugar derivatives, as monomers.

Further preferred copolymers are those that have, as monomers, by preference acrolein and acrylic acid/acrylic acid salts, or acrolein and vinyl acetate.

Also to be mentioned as further preferred builder substances are polymeric aminodicarboxylic acids, their salts, or their precursor substances. Polyaspartic acids and their salts and derivatives are particularly preferred.

Other suitable builder substances are polyacetals, which can be obtained by reacting dialdehydes with polyolcarboxylic acids that have 5 to 7 C atoms and at least 3 hydroxy groups. Preferred polyacetals are obtained from dialdehydes such as glyoxal, glutaraldehyde, terephthalaldehyde, and mixtures thereof, and from polyolcarboxylic acids such as gluconic acid and/or glucoheptonic acid.

Other suitable organic builder substances are dextrins, for example, oligomers or polymers of carbohydrates, which can be obtained by partial hydrolysis of starches. The hydrolysis can be performed in accordance with usual, e.g. acid- or enzyme-catalyzed, methods. Preferably these are hydrolysis products having average molar weights in the range from 400 to 500,000 g/mol. A polysaccharide having a dextrose equivalent (DE) in the range from 0.5 to 40, in particular, from 2 to 30, is preferred, DE being a common indicator of the reducing effect of a polysaccharide as compared with dextrose, which possesses a DE of 100. Both maltodextrins having a DE between 3 and 20, and dry glucose syrups having a DE between 20 and 37, and so-called yellow dextrins and white dextrins having higher molar weights in the range from 2,000 to 30,000 g/mol, are usable.

The oxidized derivatives of such dextrins are their reaction products with oxidizing agents that are capable of oxidizing at least one alcohol function of the saccharide ring to the carboxylic acid function. A product oxidized at C₆ of the saccharide ring can be particularly advantageous.

Oxydisuccinates and other derivatives of disuccinates, preferably ethylenediamine disuccinate, are also additional suitable co-builders. Ethylenediamine N,N′-disuccinate (EDDS) is used here preferably in the form of its sodium or magnesium salts. Also preferred in this context are glycerol disuccinates and glycerol trisuccinates. Suitable utilization quantities in zeolite-containing and/or silicate-containing products of direct (spray) drying are between 3 and 15 wt %.

Iminodisuccinates (IDS) and their derivatives, for example, hydroxyiminodisuccinates (HIDS), are appropriate as further co-builders that can be contained together with phosphonates, but also as a partial to complete substitute for phosphonates. It has been known for some years that these raw materials can be used in washing and cleaning agents as co-builders. The use of HIDS in washing and cleaning agents is already described, for example, in patent applications WO 92/02489 and DE 43 11 440. European Patent Application EP 0 757 094 discloses the advantageous use of iminodisuccinates in combination with polymers that comprise repeating succinyl units. It has more recently been discovered that IDS- or HIDS-containing agents can contribute positively to the color retention of textiles.

Other usable organic co-builders are, for example, acetylated hydroxycarboxylic acids and their salts, which, if applicable, can also be present in lactone form and which contain at least 4 carbon atoms and at least one hydroxy group, as well as a maximum of two acid groups.

A further substance class having co-builder properties is represented by the phosphonates. These are, in particular, hydroxyalkane- and aminoalkanephosphonates. Among the hydroxyalkanephosphonates, 1-hydroxyethane-1,1-diphosphonate (HEDP) is particularly important as a co-builder. It is preferably used as a sodium salt, in which context the disodium salt reacts neutrally and the tetrasodium salt in alkaline fashion (pH 9). Suitable aminoalkanephosphonates are, by preference, ethylenediamine tetramethylenephosphonate (EDTMP), diethylenetriamine pentamethylenephosphonate (DTPMP), and their higher homologs. They are preferably used in the form of the neutrally reacting sodium salts, e.g., as a hexasodium salt of EDTMP or as a hepta- and octasodium salt of DTPMP. Of the class of phosphonates, HEDP is preferably used as a builder. The aminoalkanephosphonates furthermore possess a pronounced heavy-metal binding capability. It may accordingly be preferred, especially when the agents also contain bleaches, to use aminoalkanephosphonates, in particular, DTPMP, or mixtures of the aforesaid phosphonates.

All compounds that are capable of forming complexes with alkaline-earth ions can also be contained as co-builders in the particles according to the present invention, in particular, in the direct products of (spray) drying.

Also appropriate for concurrent use in the context of (spray) drying according to the present invention are, in particular, components from the classes of the graying inhibitors (soil carriers), the neutral salts, and the textile-softening adjuvants, as well as other usual washing-agent constituents.

The purpose of graying inhibitors is to keep dirt released from the fibers suspended in the bath, thus preventing the dirt from redepositing. Water-soluble colloids, usually organic in nature, are suitable for this, for example the water-soluble salts of polymeric carboxylic acids, size, gelatin, salts of ethercarboxylic or ethersulfonic acids of starch or cellulose, or salts of acid sulfuric acid esters of cellulose or starch. Water-soluble polyamides containing acid groups are also suitable for this purpose. Soluble starch preparations, and starch products other than those mentioned above, can also be used, ergo, degraded starch, aldehyde starches, etc. Polyvinylpyrrolidone is also usable. It is preferred, however, to use cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof, as well as polyvinylpyrrolidone, e.g., in quantities from 0.1 to 5 wt % based on the direct products of (spray) drying.

Suitable softeners are, for example, swellable sheet silicates along the lines of corresponding montmorillonites, for example, bentonite.

The water content in the direct product of (spray) drying is by preference 0 to less than 25 wt %, and in particular 0.5 to 20 wt %, values of a maximum of 15 wt % being particularly preferred. The water adhering to aluminum silicates, such as zeolite, that may be present was not included in this calculation.

Individual odorant compounds, e.g., synthetic products of the ester, ether, aldehyde, ketone, alcohol, and hydrocarbon types, can be used as perfume oils or fragrances. Odorant compounds of the ester type are, for example, benzyl acetate, phenoxyethyl isobutyrate, p-tert.-butylcyclohexyl acetate, linalyl acetate, dimethylbenzylcarbinyl acetate, phenylethyl acetate, linalyl benzoate, benzyl formate, ethylmethylphenyl glycinate, allylcyclohexyl propionate, styrallyl propionate, and benzyl salicylate. The ethers include, for example, benzylethyl ether, the aldehydes, e.g., the linear alkanals having 8 to 18 C atoms, citral, citronellal, citronellyloxyacetaldehyde, cyclamenaldehyde, hydroxycitronellal, lilial, and bourgeonal; the ketones, for example, the ionones, α-isomethylionone, and methylcedryl ketone; the alcohols, anethol, citronellol, eugenol, geraniol, linalool, phenylethyl alcohol, and terpineol; the hydrocarbons include principally the terpenes such as limonene and pinene. Preferably, however, mixtures of different odorants that together produce an appealing fragrance note are used. Perfume oils of this kind can also contain natural odorant mixtures such as those accessible from plant sources, for example, pine, citrus, jasmine, patchouli, rose, or ylang-ylang oil. Also suitable are muscatel, salvia oil, chamomile oil, clove oil, melissa oil, mint oil, cinnamon leaf oil, linden blossom oil, juniper oil, vetiver oil, olibanum oil, galbanum oil, and labdanum oil, as well as orange-blossom oil, neroli oil, orange-peel oil, and sandalwood oil.

According to a further preferred embodiment, the perfume encompasses a perfume fixative, by preference in the form of diethyl phthalates, musk (derivatives), and mixtures thereof, the fixative quantity being by preference 1 to 55 wt %, advantageously 2 to 50 wt %, with further advantage 10 to 45 wt %, in particular, 20 to 40 w % of the entire quantity of perfume.

According to a further preferred embodiment, the particles contain an agent that elevates the viscosity of liquids, in particular of perfume, by preference PEG (polyethylene glycol), advantageously having a molecular weight from 400 to 2,000, the viscosity-elevating agent being contained preferably in quantities from 0.1 to 20 wt %, advantageously from 0.15 to 10 wt %, with further advantage from 0.2 to 5 wt %, in particular from 0.25 to 3 wt %, based on the particle.

It is preferred if the added fragrances also encompass those systems that have a retarding effect in terms of fragrance release. Such systems may be inferred from the existing art. Reference may be made in this connection especially to the class of the silicic acid esters, in particular, to those systems that are disclosed in European Applications EP 1112273 and EP 1263405 (both Henkel), to the entirety of which reference is hereby made. These silicic acid esters are notable, inter alia, for a long-lasting fragrance release, and moreover bring about a prolongation of the scent effect of other fragrances. European Patent Applications EP 0 998 911, EP 0 982 313, and EP 0 982 022 of General Electric, to the entirety of which reference is hereby made, describe nonvolatile polymeric, copolymeric, or oligomeric siloxanes in which one or more organic substituents are radicals of certain alcohols, aldehydes, ketones, or esters, which impart certain advantageous properties both to the siloxanes as such and to compositions into which the corresponding siloxanes are incorporated. If these alcohols, aldehydes, ketones, or esters are fragrant compounds such as, for example, para-anise alcohol, safranal, carvone, citronellyl ester (to name only one example each of such an alcohol, aldehyde, ketone, and ester), the relevant siloxanes are then likewise very advantageous in terms of long-lasting fragrance release.

In a further embodiment of the invention, the direct products of (spray) drying and/or the above-described post-treated products can be processed, in particular, mixed, with further constituents of washing and cleaning agents, it being advantageous that constituents that are not accessible to (spray) drying can be mixed in. From the extensive existing art, it is commonly known which ingredients of washing and cleaning agents are not accessible to (spray) drying and which raw materials are usually mixed in. High-temperature-sensitive mixture constituents of washing and cleaning agents are, in particular, mixed in, such as bleaching agents based on per-compounds; bleach activators and/or bleach catalysts; enzymes from, for example, the classes of the proteases, lipases, cellulases, and/or amlyases, or from bacterial strains or fungi, combinations of two or more of the enzyme classes being particularly preferred; foam inhibitors in, as applicable, granular and/or compounded form; perfumes; temperature-sensitive dyes; and the like. These can usefully be mixed with the previously dried compositions and, if applicable, post-treated products.

It is likewise possible to mix in at a later time UV absorbers that are absorbed onto the treated textiles and improve the light-fastness of the fibers and/or the light-fastness of other formula constituents. “UV absorbers” are understood as organic substances (light protection filters) that are capable of absorbing ultraviolet rays and re-emitting the absorbed energy in the form of longer-wave radiation, e.g. heat. Compounds that exhibit these desired properties are, for example, the compounds and derivatives of benzophenone, with substituents in the 2- and/or 4-position, that are effective by radiationless deactivation. Also suitable are substituted benzotriazoles, acrylates phenyl-substituted in the 3-position (cinnamic acid derivatives), if applicable having cyano groups in the 2-position, salicylates, organic Ni complexes, and natural substances such as umbelliferon and body-derived urocanic acid. Particularly important are biphenyl derivatives and especially stilbene derivates, such as those described, e.g., in EP 0728749 A and available commercially as Tinosorb® FD or Tinosorb® FR from Ciba. To be mentioned as UV-B absorbers are 3-benzylidene camphor and 3-benzylidene norcamphor and its derivatives, e.g. 3-(4-methylbenzylidene) camphor, as described in EP 0693471 B1; 4-aminobenzoic acid derivatives, preferably 4-(dimethylamino)benzoic acid 2-ethylhexyl ester, 4-(dimethylamino)benzoic acid 2-octyl ester, and 4-(dimethylamino)benzoic acid amyl ester; esters of cinnamic acid, preferably 4-methoxycinnamic acid 2-ethylhexyl ester, 4-methoxycinnamic acid propyl ester, 4-methoxycinnamic acid isoamyl ester, 2-cyano-3,3-phenylcinnamic acid 2-ethylhexyl ester (octocrylene); esters of salicylic acid, preferably salicylic acid 2-ethylhexyl ester, salicylic acid 4-isopropylbenzyl ester, salicylic acid homomethyl ester; benzophenone derivatives, preferably 2-hydroxy-4-methoxybenzophenone, 2-hydroxy-4-methoxy-4′-methylbenzophenone, 2,2′-dihydroxy-4-methoxybenzophenone; esters of benzalmalonic acid, preferably 4-methoxybenzalmalonic acid di-2-ethylhexyl ester; triazine derivatives such as, for example, 2,4,6-trianilino-(p-carbo-2′-ethyl-1′-hexyloxy)-1,3,5-triazine and octyl triazone as described in EP 0818450 A1, or dioctyl butamido triazone (Uvasorb® HEB); propane-1 3-diones such as, for example, 1-(4-tert.-butylphenyl)-3-(4′-methoxyphenyl)propane-1,3-dione; ketotricyclo(5.2.1.0)decane derivatives, such as those described in EP 0694521 B1. Also suitable are 2-phenylbenzimidazole-5-sulfonic acid and its alkali, alkaline-earth, ammonium, alkylammonium, alkanolammonium, and glucammonium salts; sulfonic acid derivatives of benzophenones, by preference 2-hydroxy-4-methoxybenzophenone-5-sulfonic acid and its salts, sulfonic acid derivatives of 3-benzylidene camphor such as, for example, 4-(2-oxo-3-bornylidenemethyl) benzenesulfonic acid and 2-methyl-5-(2-oxo-3-bornylidene)sulfonic acid and its salts.

Typical UV-A filters that are suitable are, in particular, derivatives of benzoyl methane, for example 1-(4′-tert.-butylphenyl)-3-(4′-methoxyphenyl)propane-1,3-dione, 4-tert.-butyl-4′-methoxydibenzoyl methane (Parsol 1789), 1-phenyl-3-(4′-isopropylphenyl)propane-1,3-dione, and enamine compounds as described in DE 19712033 A1 (BASF). The UV-A and UV-B filters can, of course, also be used in mixtures. In addition to the aforementioned soluble substances, insoluble light-protection pigments, namely finely dispersed, preferably nanoized metal oxides or salts, are also possible for this purpose. Examples of suitable metal oxides are, in particular, zinc oxide and titanium oxide, and also oxides of iron, zirconium, silicon, manganese, aluminum, and cerium, as well as mixtures thereof. Silicates (talc), barium sulfate, or zinc stearate can be used as salts. The oxides and salts are already used in the form of pigments for skin-care and skin-protection emulsions and decorative cosmetics. The particles should have an average diameter of less than 100 nm, by preference from 5 to 50 nm, and in particular from 15 to 30 nm. They can have a spherical shape, but particles of this kind that possess an ellipsoidal shape, or one otherwise deviating from the spherical conformation, can also be used. The pigments can also be present in surface-treated form, i.e. hydrophilized or hydrophobized. Typical examples are coated titanium dioxides, for example titanium dioxide T 805 (Degussa) or Eusolex® T2000 (Merck). Suitable as hydrophobic coating agents are chiefly silicones and especially trialkoxyoctylsilanes or simethicones. Micronized zinc oxide is preferably used. Further suitable UV light protection filters may be inferred from the overview by P. Finkel in SÖFW-Journal 122, 543 (1996).

The UV absorbers are usually used in quantities from 0.01 wt % to 5 wt %, by preference from 0.03 wt % to 1 wt %, based on the entire resulting agent. In exceptional cases, they can also be contained in the direct product of (spray) drying.

Possible other particle constituents, for example, so-called speckles, which contrast, by their color and/or shape, with the appearance of the direct and/or post-treated products of (spray) drying. The speckles can have a particle-size spectrum that is similar or identical to that of the direct and/or post-treated products of (spray) drying, and can have the same composition but a different color. It is likewise possible for the speckles to have the same composition as the direct and/or post-treated products of (spray) drying and not to be colored, but to have a different shape. Lastly, however, it is preferred that speckles which have the same composition as the direct and/or post-treated products of (spray) drying differ from the latter in terms of color and, if applicable, additionally in terms of their shape. In such cases the speckles are intended only to contribute toward making the appearance of the completed washing and cleaning agents even more attractive.

In a further and definitely preferred embodiment of the invention, however, the speckles have a different chemical composition than the direct and/or post-treated products of (spray) drying. Here, in particular, the end user can be informed, on the basis of a different color and/or a different shape, that specific ingredients are contained in the end product for specific purposes, for example bleaching or care-providing aspects. These speckles can not only be spherical to rod-shaped, but can also represent very different forms.

The mixed-in speckles, or even other ingredients, can be, for example, spray-dried, agglomerated, granulated, pelletized, or extruded. With regard to extrusion methods, reference is made here in particular to the disclosures in European Patent EP 0486592 B1 and International Patent Application WO 98/112299. Because it is an advantage of the direct products of (spray) drying and/or those post-treated according to the present invention that they possess an outstanding dissolution speed even in relative cold water (30° C.), it is, of course, preferred to mix into them further ingredients and/or raw materials that likewise exhibit an outstanding dissolution speed. In a preferred embodiment of the invention, raw materials that were manufactured according to the disclosure of International Patent Application WO 99/28433 are therefore mixed in.

The subject matter of the present invention is thus, in a further embodiment, a foodstuff washing and cleaning agent (detergent composition), or care-providing agent that contains the direct product of (spray) drying according to the present invention and/or such product post-treated according to the present invention, advantageously in quantities from 0.5 to 99.5 wt %, with further advantage from 1 to 95 wt %, with even further advantage from 5 to 90 wt %, with advantage 10 to 80 wt %, by preference 20 to 70 wt %, and in particular 30 to 60 wt %, as well as further mixed-in constituents. These further constituents contain advantageously 0.01 wt % to 95 wt %, by preference 5 wt % to 85 wt %, even more advantageously 3 wt % to 30 wt %, in particular 5 wt % to 22 wt % surfactant(s), based on the entire quantity of these further mixed-in constituents.

A further subject of the invention is a detergent composition (washing and cleaning agent) containing
(a) particles according to the present invention;
(b) 0.01 wt % to 95 wt %, by preference 5 wt % to 85 wt %, advantageously 3 wt % to 30 wt %, in particular 5 wt % to 22 wt % additional surfactant(s),
   as well as, optionally, further constituents.

Further suitable ingredients of a washing and cleaning agent according to the present invention will be described below, which ingredients can be contained in the particles according to the present invention and/or in the mixed-in components. A washing and cleaning agent according to the present invention is, by preference, made up of mixed-in components and the particles according to the present invention.

Among the compounds yielding H₂O₂ in water that serve as bleaching agents, sodium perborate tetrahydrate, and sodium perborate monohydrate are of particular importance. Other usable bleaching agents are, for example, sodium percarbonate, peroxypyrophosphates, citrate perhydrates, and peracid salts or peracids that yield H₂O₂, such as perbenzoates, peroxyphthalates, diperazelaic acid, phthaloimino peracid, or diperdodecanedioic acid.

In a preferred embodiment, washing and cleaning agents according to the present invention are notable for the fact that they contain bleaching agent, by preference, sodium percarbonate and/or halogen bleaching agent, in quantities from 0.5 to 80 wt %, by preference, from 2.5 to 70 wt %, particularly preferably, from 5 to 60 w %, and, in particular from 10 to 50 wt %, based in each case on the total mass of the agent.

Bleach activators can be contained in washing and cleaning agents according to the present invention in order to achieve an improved bleaching effect when cleaning at temperatures of 60° C. and below. Compounds that, under perhydrolysis conditions, yield aliphatic peroxycarboxylic acids having preferably 1 to 10 C atoms, in particular 2 to 4 C atoms, and/or optionally substituted perbenzoic acid, can be used as bleach activators. Substances that carry O- and/or N-acyl groups having the aforesaid number of C atoms, and/or optionally substituted benzoyl groups, are suitable. Multiply acylated alkylenediamines, in particular, tetraacetylethylenediamine (TAED), acylated triazine derivatives, in particular, 1,5-diacetyl-2,4-dioxyhexahydro-1,3,5-triazine (DADHT), acylated glycolurils, in particular, tetraacetylglycoluril (TAGU), N-acylimides, in particular, N-nonanoyl succinimide (NOSI), acylated phenolsulfonates, in particular, n-nonanoyl or isononanoyl oxybenzenesulfonate (n- and iso-NOBS), carboxylic acid anhydrides, in particular, phthalic acid anhydride, acylated polyvalent alcohols, in particular, triacetin, ethylene glycol diacetate, and 2,5-diacetoxy-2,5-dihydrofuran, are preferred.

In addition to or instead of the conventional bleach activators, so-called bleach catalysts can also be contained in washing and cleaning agents according to the present invention. These substances are bleach-intensifying transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru ammine complexes, are also applicable as bleach catalysts.

Suitable enzymes are those of the class of the proteases, lipases, amylases, cellulases, and mixtures thereof. Enzymatic active substances obtained from bacterial strains or fungi, such as Bacillus subtilis, Bacillus licheniformis, Streptomyceus griseus, and Humicola insolens, are particularly suitable. Proteases of the subtilisin type, and, in particular, proteases obtained from Bacillus lentus, are preferably used. Enzyme mixtures, for example of protease and amylase or protease and lipase or protease and cellulase, or of cellulase and lipase, or of protease, amylase, and lipase or protease, lipase, and cellulase, but, in particular, cellulase-containing mixtures, are of particular interest in this context. Peroxidases or oxidases have also proven suitable in certain cases. The enzymes can be adsorbed onto carrier substances and/or embedded into encasing substances in order to protect them from premature decomposition. The proportion of the enzymes, enzyme mixtures, or enzyme granules in the washing and cleaning agents according to the present invention can be, for example, approximately 0.1 to 5 wt %, by preference 0.1 to approximately 2 wt %.

Washing and cleaning agents according to the invention also contain, according to a particularly preferred embodiment, further additives that are known from the existing art as additives for washing and cleaning agents. One preferred group of additives utilized according to the present invention is optical brighteners. The optical brighteners usual in washing agents can be utilized here. Examples of optical brighteners are derivatives of diaminostilbenesulfonic acid or its alkali-metal salts. Suitable, for example, are salts of 4,4′-bis(2-anilino-4-morpholino-1,3,5-triazinyl-6-amino)stilbene-2,2′-disulfonic acid, or compounds of similar structure that carry, instead of the morpholino group, a diethanolamino group, a methylamino group, an anilino group, or a 2-methoxyethylamino group. Brighteners of the substituted diphenylstyryl type can also be contained in the washing-agent preparations according to the present invention, e.g. the alkali salts of 4,4′-bis(2-sulfostyryl)diphenyl, of 4,4′-bis(4-chloro-3-sulfostyryl)diphenyl, or of 4-(4-chlorostyryl)-4′-(2-sulfostyryl)diphenyl. Mixtures of the aforesaid brighteners can also be used.

Disintegration adjuvants, by preference a cellulose-based disintegration adjuvant, can likewise be among the relevant ingredients. Well-known disintegration adjuvants are, for example, carbonate/citric acid systems; other organic acids can also be used. Swelling disintegration adjuvants are, for example, synthetic polymers such as polyvinylpyrrolidone (PVP), or natural polymers or modified natural substances such as cellulose and starch and their derivates, alginates, or casein derivatives, All the aforesaid disintegration adjuvants are usable according to the present invention.

The agents can contain antioxidants in order to prevent undesired changes, caused by the action of oxygen and other oxidative processes, to the washing- and cleaning-agent preparations and/or the treated textiles. This class of compounds includes, for example, substituted phenols, hydroquinones, catechols, and aromatic amines, as well as organic sulfides, polysulfides, dithiocarbamates, phosphites, and phosphonates.

Increased wearing comfort for washed clothing can result from the additional use of antistatic agents. Antistatic agents increase the surface conductivity and thus make possible improved dissipation of charges that have formed. External antistatic agents are usually substances having at least one hydrophilic molecule ligand, and form a more or less hygroscopic film on the surfaces. These usually surface-active antistatic agents can be subdivided into nitrogen-containing (amines, amides, quaternary ammonium compounds), phosphorus-containing (phosphoric acid esters), and sulfur-containing antistatic agents (alkylsulfonates, alkyl sulfates), Lauryl (or stearyl) dimethylbenzylammonium chlorides are likewise suitable as antistatic agents for textiles or as an additive to washing agents, an avivage effect additionally being achieved.

For textile care and in order to improve textile properties, such as a softer “hand” (avivage) and decreased electrostatic charge (increased wearing comfort), the agents according to the present invention can contain conditioners or avivage agents. Quaternary ammonium compounds having two hydrophobic radicals are preferred, such as, for example, distearyldimethylammonium chloride, although because of its insufficient biodegradability the latter is increasingly being replaced by quaternary ammonium compounds that contain ester groups in their hydrophobic radicals as defined break points for biodegradation (esterquats).

In a preferred embodiment, the additives contain avivage agents, by preference cationic surfactants, in particular quaternary ammonium compounds.

In a preferred embodiment, the agents according to the present invention are notable for the fact that they contain avivage agents, by preference cationic surfactant(s), in particular alkylated quaternary ammonium compounds of which at least one alkyl chain is interrupted by an ester group and/or amido group, in quantities from 0.5 to 80 wt %, by preference 2.5 to 70 wt %, particularly preferably 5 to 60 wt %, and, in particular, 10 to 50 wt %, based in each case on the total mass of the agent.

Suitable examples are quaternary ammonium compounds of formulas (1) and (2)

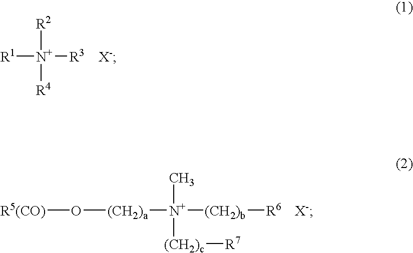

where in (1), R¹ and R² denote an acyclic alkyl radical having 12 to 24 carbon atoms; R³ denotes a saturated C₁-C₄ alkyl or hydroxyalkyl radical; and R⁴ either is identical to R¹, R², or R³ or denotes an aromatic radical. X⁻ denotes either a halide, methosulfate, methophosphate, or phosphate ion, and mixtures thereof. Examples of cationic compounds of formula (1) are didecyldimethylammonium chloride, ditallowedimethylammonium chloride, or dihexadecylammonium chloride.

Compounds of formula (2) are so-called esterquats. Agents according to the present invention that are notable for containing a quaternary ammonium compound according to formula (2) represent preferred embodiments of the invention, Esterquats are characterized by outstanding biodegradability. Here R⁵ denotes an aliphatic alkyl radical having 12 to 22 carbon atoms with 0, 1, 2, or 3 double bonds; R⁶ denotes H, OH, or O(CO)R⁸; and R⁷ denotes, independently of R⁶, H, OH, or O(CO)R⁸, R⁸ and R⁹ each denoting, mutually independently, an aliphatic alkyl radical having 12 to 22 carbon atoms with 0, 1, 2, or 3 double bonds. a, b, and c can each, mutually independently, have a value of 1, 2, or 3. X⁻ can be either a halide, methosulfate, methophosphate, or phosphate ion, as well as mixtures thereof. Compounds that contain the group O(CO)R⁸ for R⁶, and alkyl radicals having 16 to 18 carbon atoms for R⁵ and R⁸, are preferred. Compounds in which R⁷ additionally denotes OH are particularly preferred. Examples of compounds of formula (2) are methyl-N-(2-hydroxyethyl)-N,N-di(tallowacyloxyethyl)ammonium methosulfate, bis-(palmitoyl)ethylhydroxyethylmethylammonium methosulfate, or methyl-N,N-bis(acyloxyethyl)-N-(2-hydroxyethyl)ammonium methosulfate. If quaternized compounds of formula (2) having unsaturated alkyl chains are used, those acyl groups whose corresponding fatty acids have an iodine number of between 5 and 80, preferably between 10 and 60, and, in particular, between 15 and 45, and that have a cis/trans isomer ratio (in wt %) greater than 30:70, by preference greater than 50:50, and in particular greater than 70:30, are preferred. Commercial examples are the methylhydroxyalkyldialkoyloxyalkylammonium methosulfates marketed by Stepan under the trade name Stepantex®, or the products of Cognis known as Dehyquat®, or the products of Goldschmidt-Witco known as Rewoquat®. Further preferred compounds are the diesterquats of formula (3) that are obtainable under the name Rewoquat® W 222 LM or CR 3099:

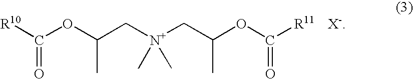

Here R¹⁰ at and R¹¹ each denote, mutually independently, an aliphatic radical having 12 to 22 carbon atoms with 0, 1, 2, or 3 double bonds.

In addition to the quaternary compounds just described, other known compounds, for example quaternary imidazolinium compounds of formula (4), can also be contained in the agents:

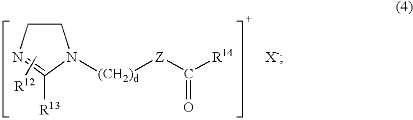

in which R¹² denotes H or a saturated alkyl radical having 1 to 4 carbon atoms; R¹³ and R¹⁴ each, mutually independently, denote an aliphatic, saturated, or unsaturated alkyl radical having 12 to 18 carbon atoms; R¹³ can alternatively also denote O(CO)R¹⁵, where R¹⁵ signifies an aliphatic, saturated, or unsaturated alkyl radical having 12 to 18 carbon atoms; Z signifies an NH group or oxygen; and X⁻ is an anion. d can assume integer values between 1 and 4.

Further suitable quaternary compounds are described by formula (5)

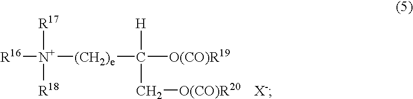

in which R¹⁶, R¹⁷, and R¹⁸, mutually independently, denote a C₁₋₄ alkyl, alkenyl, or hydroxyalkyl group; R¹⁹ and R²⁰, each selected independently, represent a C₈₋₂₈ alkyl group; and e is a number between 0 and 5. X⁻ is a suitable anion, by preference a halide, methosulfate, methophosphate, or phosphate ion, and mixtures thereof. Agents according to the present invention that are notable for the fact that they contain a quaternary ammonium compound according to formula (5) are particularly preferred.

In addition to the compounds of formulas (1) and (2), short-chain water-soluble quaternary ammonium compounds can also be used, such as trihydroxyethylmethylammonium methosulfate or the alkyltrimethylammonium chlorides, dialkyldimethylammonium chlorides, and trialkylmethylammonium chlorides, e.g., cetyltrimethylammonium chloride, stearyltrimethylammonium chloride, distearyldimethylammonium chloride, lauryldimethylammonium chloride, lauryldimethylbenzylammonium chloride, and tricetylmethylammonium chloride.

Also suitable are protonated alkylamine compounds that have a softening effect, as well as the unquaternized protonated precursors of the cationic emulsifiers.

The quaternized protein hydrolysates represent further cationic compounds usable according to the present invention that can be contained in the agents.

Also usable are compounds of formula (6)

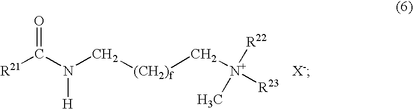

which can be alkylamidoamines in their unquaternized or, as depicted, quaternized form. R²¹ can be an aliphatic alkyl radical having 12 to 22 carbon atoms with 0, 1, 2, or 3 double bonds. f can assume values between 0 and 5. R²² and R²³ each denote, mutually independently, H, C₁₋₄ alkyl or hydroxyalkyl. Preferred compounds are fatty acid amidoamines such as the stearylamidopropyldimethylamine obtainable under the name Tego Amide® S18, or the 3-tallowamidopropyltrimethylammonium methosulfate obtainable under the name Stepantex® X 9124, which are distinguished not only by a good conditioning action but also by a color transfer-inhibiting effect, and especially by their good biodegradability. Particularly preferred are alkylated quaternary ammonium compounds in which at least one alkyl chain is interrupted by an ester group and/or amido group, in particular, N-methyl-N(2-hydroxyethyl)-N,N-(ditaflowacyloxyethyl)ammonium methosulfate and/or N-methyl-N(2-hydroxyethyl)-N,N-(dipaimitoyloxyethyl)ammonium methosulfate.

In order to improve the water absorption capability and rewettability of the treated textiles and to facilitate ironing of the treated textiles, silicone derivatives, for example, can be used in the agents according to the present invention. These additionally improve the rinsing behavior of the agents according to the present invention as a result of their foam-inhibiting properties. Preferred silicone derivatives are, for example, polydialkyl- or alkylarylsiloxanes in which the alkyl groups have one to five C atoms and are entirely or partly fluorinated. Preferred silicones are polydimethylsiloxanes, which optionally can be derivatized and are then amino functional or quaternized or have Si—OH, Si—H, and/or Si—Cl bonds.

Because textile fabrics, in particular those made of rayon, viscose, cotton, and mixtures thereof, can tend to wrinkle because the individual fibers are sensitive to bending, kinking, pressing, and squeezing transversely to the fiber direction, the washing agents according to the present invention can contain synthetic wrinkle-protection agents. These include, for example, synthetic products based on fatty acids, fatty acid esters, fatty acid amides, alkylol esters, alkylolamides, or fatty alcohols that are usually reacted with ethylene oxide, or products based on lecithin or modified phosphoric acid esters.

To counteract microorganisms, the agents according to the present invention can contain antimicrobial active substances. A distinction is made here, in terms of the antimicrobial spectrum and mechanism of action, between bacteriostatics and bactericides, fungistatics and fungicides, etc. Important substances from these groups are, for example, benzalkonium chlorides, alkylarylsulfonates, halogen phenols, and phenol mercuric acetate. The terms “antimicrobial action” and “antimicrobial active substance” have, in the context of the teaching of the present invention, the meaning usual in the art, as reproduced, e.g., by K, H. Wallhäuser, “Praxis der Sterilisation, Desinfektion, Konservierung: Keimidentifizierung-Betriebshygiene” [Sterilization, disinfection, preservation practice: Germ identification-Industrial hygiene], 5th ed., Stuttgart, New York; Thieme, 1995); all substances having an antimicrobial action described therein can be used. Suitable antimicrobial active substances are by preference selected from the groups of the alcohols, amines, aldehydes, antimicrobial acids and salts thereof, carboxylic acid esters, acid amides, phenols, phenol derivatives, diphenyls, diphenylalkanes, urea derivatives, oxygen and nitrogen acetals and formals, benzamidines, isothiazolines, phthalimide derivatives, pyridine derivatives, antimicrobial surface-active compounds, guanidines, antimicrobial amphoteric compounds, quinolines, 1,2-dibromo-2,4-dicyanobutane, iodo-2-propylbutylcarbamate, iodine, iodophores, peroxo compounds, halogen compounds, and any mixtures of the aforementioned compounds and compound groups.

The antimicrobial active substance can be selected from the group of the compounds recited below, in which context one or more of the compounds recited can be used: ethanol, n-propanol, i-propanol, 1,3-butanediol, phenoxyethanol, 1,2-propylene glycol, glycerol, undecylenic acid, benzoic acid, salicylic acid, dihydracetic acid, o-phenylphenol, N-methylmorpholinoacetonitrile (MMA), 2-benzyl-4-chlorophenol, 2,2′-methylene-bis-(6-bromo-4-chlorophenol), 4,4′-dichloro-2′-hydroxydiphenylether (diclosan), 2,4,4′-trichloro-2′-hydroxydiphenylether (triclosan), chlorhexidine, N-(4-chlorophenyl)-N-(3,4-dichlorophenyl) urea, N,N-(1,10-decanediyldi-1-pyridinyl-4-ylidene)-bis-(1-octaneamine) dihydrochloride, N,N′-bis-(4-chlorophenyl)-3,12-diimino-2,4,11,13-tetraazatetradecanediimideamide, glucoprotamines, antimicrobial surface-active quaternary compounds, guanidines including the bi- and polyguanidines such as, for example, 1,6-bis-(2-ethylhexylbiguanidohexane) dihydrochloride. 1,6-di-(N₁,N₁′-phenyldiguanido-N₅, N₅′-)hexane tetrahydrochloride, 1,6-di-(N₁,N₁′-phenyl-N₁,N₁-methyldiguanido-N₅,N₅′-)hexane dihydrochloride, 1,6-di-(N₁,N₁′-o-chlorophenyldiguanido-N₅,N₅′-)hexane dihydrochloride, 1,6-di-(N₁,N₁′-2,6-dichlorophenyldiguanido-N₅,N₅′-)hexane dihydrochloride, 1,6-di-[N₁,N₁′-beta-(p-methoxyphenyl-)diguanido-N₅,N₅′-]hexane dihydrochloride, 1,6-di-(N₁,N₁′-alpha-methyl-beta-phenyldiguanido-N₅,N₅′-)hexane dihydrochloride, 1,6-di-(N₁,N₁′-p-nitrophenyldiguanido-N₅,N₅′-)hexane dihydrochloride, omega: omega-di-(N₁,N₁′-phenyldiguanido-N₅,N₅′-)di-n-propyl ether dihydrochloride, omega: omega′-di-(N₁,N₁′-p-chlorophenyldiguanido-N₅,N₅′-)di-n-propyl ether tetrahydrochloride, 1,6-di-(N₁,N₁′-2,4-dichlorophenyldiguanido-N₅,N₅′-)hexane tetrahydrochloride, 1,6-di-(N₁,N₁′-p-methylphenyldiguanido-N₅,N₅′-)hexane dihydrochloride, 1,6-di-(N₁,N₁′-2,4,5-trichlorophenyydiguanido-N₅,N₅′-)hexane tetrahydrochloride, 1,6-di-[N₁,N₁′-alpha-(p-chlorophenyl)ethyldiguanido-N₅, N₅′]hexane dihydrochloride, omega:omega-di-(N₁,N₁′-p-chlorophenyldiguanido-N₅, N₅′-)m-xylene dihydrochloride, 1,12-di-(N₁, N₁′-p-chlorophenyldiguanido-N₅,N₅′-)dodecane dihydrochloride, 1,10-di-(N₁,N₁′-phenyldiguanido-N₅,N₅′-)decane tetrahydrochloride, 1,12-di-(N₁,N₁′-phenyldiguanido-N₅,N₅′-)dodecane tetrahydrochloride, 1,6-di-(N₁,N₁′-chlorophenyldiguanido-N₅, N₅′-)hexane dihydrochloride, 1,6-di-(N₁,N₁′-o-chlorophenyldiguanido-N₅,N₅′-)hexane tetrahydrochloride, ethylene-bis-(1-tolylbiguanide), ethylene-bis-(p-tolylbiguanide), ethylene-bis-(3,5-dimethylphenylbiguanide), ethylene-bis-(p-tert.-amylphenylbiguanide), ethylene-bis-(nonylphenylbiguanide), ethylene-bis-(phenylbiguanide), ethylene-bis-(N-butylphenylbiguanide), ethylene-bis-(2,5 diethoxyphenylbiguanide), ethylene-bis-(2,4-dimethylphenylbiguanide), ethylene-bis-(o-diphenylbiguanide), ethylene-bis-(mixed amylnaphthylbiguanide), N-butylethylene-bis-(phenylbiguanide), trimethylene-bis(o-tolylbiguanide), N-butyltrimethylene-bis-(phenylbiguanide) and the corresponding salts such as acetates, gluconates, hydrochlorides, hydrobromides, citrates, bisulfites, fluorides, polymaleates, n-cocosalkylsarcosinates, phosphites, hypophosphites, perfluoroctanoates, silicates, sorbates, salicylates, maleates, tartrates, fumarates, ethylendiamintetraacetates, iminodiacetates, cinnamates, thiocyanates, arginates, pyromellitates, tetracarboxybutyrates, benzoates, glutarates, monofluorphosphates, perfluorpropionates, and any mixtures thereof. Also suitable are halogenated xylene and cresol derivatives such as p-chlorometacresol or p-chlorometaxylene, as well as natural antimicrobial active substances of vegetable origin (e.g., from spices or herbs), or animal or microbial origin. It is preferable to use antimicrobially active surface-active quaternary compounds, a natural antimicrobial active substance of vegetable origin, and/or a natural antimicrobial active substance of animal origin, extremely preferably at least one natural antimicrobial active substance of vegetable origin from the group encompassing caffeine, theobromine, and theophylline, as well as essential oils such as eugenol, thymol, and geraniol, and/or at least one natural antimicrobial active substance of animal origin, from the group encompassing enzymes such as protein from mile, lysozyme, and lactoperoxidase, and/or at least one antimicrobially acting surface-active quaternary compound having an ammonium, sulfonium, phosphonium, iodonium, or arsonium group, peroxo compounds, and chlorine compounds. Substances of microbial origin (so-called bacteriozines) can also be used.

Quaternary ammonium compounds (QAGs) that are suitable as antimicrobial active substances are, for example, benzalkonium chloride (N-alkyl-N,N-dimethylbenzylammonium chloride, CAS No. 8001-54-5), benzalkon B (m,p-dichlorobenzyldimethyl-C12-alkylammonium chloride, CAS No. 58390-78-6), benzoxonium chloride (benzyldodecyl-bis-(2-hy-droxyethyl)ammonium chloride), cetrimonium bromide (N-hexadecyl-N,N-trimethylammonium bromide, CAS No. 57-09-0), benzetonium chloride (N,N-dimethyl-N-[2-[2-[p-(1,1,3,3-tetramethylbutyl)phenoxy]ethoxy]ethyl]benzylammonium chloride, CAS No. 121-54-0), dialkyldimethylammonium chlorides such as di-n-decyldimethylammonium chloride, didecyldimethylammonium bromide (CAS No. 2390-68-3), dioctyldimethylammonium chloride, 1-cetylpyridinium chloride (CAS No. 123-03-5), and thiazoline iodide (CAS No. 15764-48-1), as well as mixtures thereof. Particularly preferred QACs are benzalkonium chlorides having C₈-C₁₈ alkyl radicals, in particular, C₁₂-C₁₄ alkylbenzyldimethylammonium chloride.

Benzalkonium halides and/or substituted benzalkonium halides are obtainable commercially, for example, as Barquat® from Lonza, Marquat® from Mason, Variquat® from Witco/Sherex, and Hyamine® from Lonza, as well as Bardac® from Lonza. Further commercially obtainable antimicrobial active substances are N-(3-chloroallyl)hexaminium chloride such as Dowicide® and Dowicil® from Dow, benzethonium chloride such as Hyamine® 1622 from Rohm & Haas, methylbenzethonium chloride such as Hyamine® 10× from Rohm & Haas, and cetylpyridinium chloride such as Cepacol chloride from Merrell Labs.

The antimicrobial active substances are used in agents according to the present invention by preference in quantities from 0.0001 wt % to 1 wt %, preferably from 0.001 wt % to 0.8 wt %, particularly preferably from 0.005 wt % to 0.3 wt %, and, in particular, from 0.01 to 0.2 wt %.

In a preferred embodiment, an agent according to the present invention contains active substances that contribute to the fiber elasticity, shape retention, and tear resistance of the textile fibers. If fibers are exposed to a moderate or severe deformation force by extending the fiber by, for example, 80%, with untreated fibers, the result of this can be that upon cancellation of the deformation force the fiber does not return, or returns only partly, to its original shape. In some circumstances the fiber can, in fact, tear. For practical reasons, the consumer, of course, desires textile fibers that do not tear or lose their original shape even when subjected to moderate or severe deformation or extension forces. It has now been found that certain active substances that can be applied onto the textile fibers in the context of a washing operation and consequently greatly improve their elasticity, shape retention, and tear resistance, so that the fibers become more elastic and more tear-resistant, are effective in particularly advantageous fashion when they are contained in the agents according to the present invention.

These active substances are preferably aminosiloxanes, cellulose derivatives, in particular, cellulose ethers, and carboxylic acid esters.

Preferred carboxylic acid esters conform to the general formula (7)

R²⁴—CO—O—(—CH₂—CH₂—O—)_{g}—R²⁵,

g being between 0 (which is preferred) and 20, R²⁵ being a monofunctional hydrocarbon radical having 6-20, by preference 8-18 carbon atoms, and R²⁴ being a monofunctional hydrocarbon radical that contains at least one hydroxy group and at least two carbon atoms, by preference selected from the following radicals:
i) —C₆Hₕ(OH)ᵢ, h being between 3 and 4 and i between 1 and 2, and the sum h+i equaling 5, in particular —C₆H₄OH;
ii) —CH(OH)—CH(R²⁶)—COO—(—CH₂—CH₂—O—)ⱼ—R²⁷, R²⁶ being H or OH, j being between 0 (which is preferred) and 20, and R²⁷ being a monofunctional hydrocarbon radical, by preference an alkyl radical having 6-20, in particular 8-18 carbon atoms;
iii) —CH(OH)—CH₃

Typical and preferred esters that conform to this formula (7) are, without being limited thereto, tridecyl salicylate (HO—C₆H₄—CO—O—(C₂H₂)₁₂—CH₃), di-(C₁₂-C₁₃)alkyl malate, di-(C₁₂-C₁₃)alkyl tartrate, and/or di-(C₁₂-C₁₃)alkyl lactate.

According to a further preferred embodiment of the invention, the particles according to the present invention are surrounded at least in part by a coating that by preference contains at least one at least partially water-soluble or at least partially water-dispersible component, which is selected in particular from polyols, carbohydrates, starches, modified starches, starch hydrolysates, cellulose and cellulose derivatives, natural and synthetic gums, silicates, borates, phosphates, chitin and chitosan, water-soluble polymers, fat components, and mixtures thereof. Also suitable, for example, are waxes and/or resins, for example beeswax, benzoin resin, carnauba wax, candelilla wax, cumaron-indene wax, copals, shellac, mastic, polyethylene wax oxidates, or sandarac resin. Paraffins or gelatins, in particular, including cellulose ethers, are also suitable.

According to a further preferred embodiment, the coating comprises polycarboxylates.

Coating of the particles can be performed in the manners described in the existing art. The coating material surrounds the respective particle by preference entirely, although a discontinuous coating can also be desirable. Appropriate coating materials are chiefly those that are commonly utilized in connection with washing and cleaning agents.

Materials that can be used as coating materials for purposes of the invention are any inorganic and/or organic substances and/or substance mixtures, by preference those that are sensitive to pH, temperature, and/or ionic strength, so that as a function of a change in pH, temperature, and/or ionic strength they lose their integrity, i.e., for example, entirely or partially dissolve.

Particularly preferred as coating materials are polymers and/or copolymers that have film-forming properties and can by preference be used from an aqueous dispersion. Organic solvents are, for numerous reasons (flammability, toxicity, etc.) disadvantageous in the context of the production of pH-sensitive coatings. Aqueous coatings are notable for easy handling and the avoidance of any toxicological problems. The critical magnitude for the film-forming properties is the glass transition temperature of the film-forming polymer and/or copolymer. Above the glass temperature, the polymer or copolymer is elastic, meltable, and flowable, whereas below the glass temperature it becomes brittle. Only above the glass transition temperature can the polymer easily be processed, as is necessary to form a film coating. The glass transition temperature can be influenced by the addition of low-molecular-weight substances having softening properties, the so-called plasticizers. In addition to the polymer, plasticizers can therefore also be used in the aqueous dispersion. Suitable as plasticizers are all substances that lower the glass transition temperature of the (by preference pH-sensitive) polymers and/or copolymers that are used. The polymer can thus be applied at lower temperatures, if applicable even at room temperature. Particularly preferred plasticizers are citric acid esters (by preference tributyl citrate and/or triethyl citrate), phthalic acid esters (by preference dimethyl phthalate, diethyl phthalate, and/or dibutyl phthalate), esters of organic polyalcohols (by preference glycerol triacetate), polyalcohols (by preference glycerol, propylene glycol), and/or polyoxyethylene glycols (by preference polyethylene glycol). The plasticizer becomes deposited between the polymer chains and thereby increases mobility, decreases interactions, and prevents friction and cracking of the film by decreasing brittleness.

It is particularly advantageous if the coating material contains a polyacrylate and/or a derivative thereof and/or a corresponding copolymer based on acrylic acid esters or acrylic acids and other monomers. Copolymers of acrylamide and acrylic acid and/or their derivatives are especially advantageous for the coating material according to the present invention.

A further subject of the invention is a method for washing textiles encompassing the step of bringing the textiles into contact with an aqueous medium that contains an effective quantity of a washing- and cleaning-agent composition (detergent composition) according to the present invention.

### EXAMPLES

In order to demonstrate the elevated absorption capacity of the particle according to the present invention, a variety of particles were manufactured by spray drying (counterflow nozzle atomization) of aqueous slurries, and the oil number of the particle was then ascertained.

The oil number is a usual parameter for characterizing the oil absorption capacity of particles. Oil numbers are determined in accordance with DIN ISO 787.

The slurry temperature before the nozzles was approximately 70° C., and approximately 120° C. during the manufacture of particle B. The tower inlet temperature was approximately 210° C. Gas consumption was approximately 150-160 m³/l.

Slurry formulation for manufacturing comparison particles by spray drying:

| | | |
|---|---|---|
| C12-C18 fatty alcohol + 4.5 EO | 1.45 | wt % |
| C12-C18 fatty alcohol + 7 EO | 0.50 | wt % |
| Zeolite A | 76.39 | wt % |
| Carboxymethyl cellulose sodium salt | 2.00 | wt % |
| Sodium hydroxide | 0.48 | wt % |
| Sodium sulfate | 1.70 | wt % |
| Water | 16.75 | wt % |
| Remainder | 0.73 | wt % |

The particles resulting therefrom exhibited the following parameters.

| Bulk weight: | 480 | g/l |
|---|---|---|
| Oil number: | 146 ml/100 g | |
| d₅₀: | 0.32 | mm |

(d₅₀ is the average particle diameter, or the feature value at which the distributed sum of the particle diameters assumes the value 0.5 = 50%. For example, the indication “d₅₀ = a mm” means that of the material in question, 50% (by mass) of the particles have a diameter greater than 1 mm, and 50% (by mass) have a diameter smaller than a mm.)

Slurry formulation for manufacturing particles A by spray drying.

| | | |
|---|---|---|
| C12-C18 fatty alcohol + 4.5 EO | 1.41 | wt % |
| C12-C18 fatty alcohol + 7 EO | 0.50 | wt % |
| Zeolite A | 74.44 | wt % |
| Carboxymethyl cellulose sodium salt | 2.00 | wt % |
| Sodium hydroxide | 0.47 | wt % |
| Sodium sulfate | 1.70 | wt % |
| Water | 16.75 | wt % |
| Sodium hydrogencarbonate | 2.00 | wt % |
| Remainder | 0.73 | wt % |

The resulting particles A exhibited the following parameters:

| Bulk weight: | 490 | g/l |
|---|---|---|
| Oil number: | 160 ml/100 g | |
| d₅₀: | 0.28 | mm |

Slurry formulation for manufacturing particles B by spray drying:

| | | |
|---|---|---|
| C12-C18 fatty alcohol + 4.5 EO | 1.39 | wt % |
| C12-C18 fatty alcohol + 7 EO | 0.50 | wt % |
| Zeolite A | 73.13 | wt % |
| Carboxymethyl cellulose sodium salt | 2.00 | wt % |
| Sodium hydroxide | 0.46 | wt % |
| Sodium sulfate | 1.70 | wt % |
| Water | 16.75 | wt % |
| Hydroxypropane-1,2,3-tricarboxylic acid * 1 H2O | 3.34 | wt % |
| Remainder | 0.73 | wt % |

The resulting particles A exhibited the following parameters:

| Bulk weight: | 500 | g/l |
|---|---|---|
| Oil number: | 160 ml/100 g | |
| d50: | 0.32 | mm |

The particles A and B according to the present invention thus exhibited oil numbers that were almost ten percent higher than those of the comparison particles.

The comparison particles, as well as particles A and B whose bulk weights and particle size distribution were on the whole comparable, additionally had perfume applied to them, specifically by mixing the perfume and the respective particles in a standard mixing unit, the maximum possible perfume absorption of the respective particles having been ascertained by way of the increase in the weight of the particles. It was found that particles A and B according to the present invention were each able to absorb approximately 10 wt % more perfume than the comparison particles. Despite the high perfume loading, particles A and B according to the present invention remained free-flowing and did not clump, even after extended storage.

1. A method for the manufacture of particles, said method comprising the step of subjecting a paste to drying, resulting in the generation of carbon dioxide and the formation of particles from the dried paste material.

2. The method according to claim 1, wherein the paste contains an inorganic carrier material selected from the group consisting of zeolites, sulfates, carbonates, silicates, silicic acid and mixtures thereof.

3. The method according to claim 1, wherein the paste additionally contains anionic or cationic surfactant.

4. The method according to claim 1, wherein the paste contains at least one constituent that releases carbon dioxide at elevated temperatures and is selected from the group consisting of hydrogen carbonate compounds, citric acid, aconitic acid and mixtures thereof.

5. The method according to claim 1 further comprising the step of subjecting the particles to post-treatment.

6. The method according to claim 5, wherein the post-treatment step comprises contacting the particle with at least one nonionic surfactant and/or perfume.

7. The method according to claim 6, wherein the post-treatment step comprises contacting the particle with perfume.

8. A particle formed by the step of subjecting a paste to drying, resulting in the generation of carbon dioxide and the formation of particles from the paste material, followed by a post-treatment step.

9. The particle of claim 8, wherein the particle is post-treated with at least one nonionic surfactant and/or perfume.

10. The particle of claim 9, wherein the particle is treated with perfume.

11. The particle of claim 8 comprising:
a) at least 30 wt. % carrier material;
b) 0.5 to 40 wt. % perfume, and
c) 0.1 to 30 wt. % nonionic surfactant.

12. The particle of claim 8, wherein said particle is surrounded by a coating.

13. The particle of claim 12, wherein the coating comprises polycarboxylates.

14. A detergent composition comprising:
a) particles manufactured by subjecting a paste to drying, resulting in the generation of carbon dioxide and the particles from the dried paste; and
b) 0.01 wt. % to 95 wt. % additional surfactants.

15. The detergent composition according to claim 14, wherein the particles comprise:
a) at least 30 wt. % carrier material;
b) 0.5 to 40 wt. % perfume; and
c) 0.1 to 30 wt. % nonionic surfactant.

16. The detergent composition according to claim 14 comprising 5 to 85 wt. % surfactant.

17. The detergent composition according to claim 14 comprising 3 to 30 wt. % surfactant.

18. The detergent composition according to claim 14 comprising 5 to 22 wt. % surfactant.

19. A method for treating textiles comprising the step of bringing the textiles into contact with an aqueous medium that contains an effective quantity of a detergent composition according to claim 14.

20. A method for washing textiles comprising the step of bringing the textiles into contact with an aqueous medium that contains an effective quantity of a detergent composition according to claim 14.
